(19) United States
(12) Patent Application Publication
(10) Pub. No.: US 2018/0197503 A1
(43) Pub. Date: Jul. 12, 2018

(54) IMAGE DISPLAY DEVICE AND IMAGE PROCESSING DEVICE

(71) Applicant: Kabushiki Kaisha Toshiba, Minato-ku (JP)

(72) Inventors: Takayuki Sasaki, Ota (JP); Jun Yamaguchi, Kawasaki (JP); Masahiro Baba, Yokohama (JP)

(73) Assignee: Kabushiki Kaisha Toshiba, Minato-ku (JP)

(21) Appl. No.: 15/914,456

(22) Filed: Mar. 7, 2018

Related U.S. Application Data
(63) Continuation of application No. PCT/JP2016/087766, filed on Dec. 19, 2016.

(30) Foreign Application Priority Data
Jan. 29, 2016 (JP) 2016-015597

(51) Int. Cl. G09G 5/02; G02B 27/01

(52) U.S. Cl. CPC G09G 5/02; G02B 27/0172; G02B 27/0179; G02B 2027/0181; G02B 2027/0112; G02B 2027/014; G02B 2027/011

(57) ABSTRACT

According to one embodiment, an image display device that includes an optical part and a controller is provided. First input image data and second input image data are input to the controller. The controller causes the optical part to emit a first light based on first corrected image data of the first input image data having been corrected. The controller causes the optical part to emit a second light when receiving a signal employing first correction information of a relationship between the first input image data and the first corrected image data, wherein the second light is based on second corrected image data of the second input image data corrected based on the first correction information.

### CROSS-REFERENCE TO RELATED APPLICATIONS

This is a continuation application of International Application PCT/JP2016/087766, filed on Dec. 19, 2016. This application also claims priority to Japanese Application No. 2016-015597, filed on Jan. 29, 2016. The entire contents of each are incorporated herein by reference.

### FIELD

Embodiments of the invention generally relate to an image display device and an image processing device.

### BACKGROUND

There is an image display device that includes a projector and a reflector (a combiner), wherein the projector includes a displayer and an optical part, the displayer displays an image, the optical part includes optical elements such as multiple lenses, etc., the projector projects the image displayed on the displayer, and the reflector reflects the image projected from the projector toward an eye of a viewer. In the image display device, optical distortion and/or partial loss of the image viewed by the viewer may occur according to the arrangement of the projector and/or the pupil position of the viewer. It is desirable for the viewer to be able to easily adjust the display to an easily-viewable state in which the optical distortion and the like are suppressed.

### BRIEF DESCRIPTION OF THE DRAWINGS

FIG. 1 is a schematic view illustrating an image display device according to a first embodiment;

FIG. 2 is a block diagram illustrating the image display device according to the first embodiment;

FIG. 3 is a block diagram illustrating the adjuster of the image display device according to the first embodiment;

FIG. 4 is a schematic view illustrating an image display device of a reference example;

FIG. 5A to FIG. 5D are schematic views illustrating the image display device of the reference example;

FIG. 6 is a schematic view illustrating image processing of the image display device according to the first embodiment;

FIG. 7A to FIG. 7G are schematic views illustrating the correction coefficients used in the image display device according to the first embodiment;

FIG. 8 is a flowchart illustrating an operation of the image display device according to the first embodiment;

FIG. 9A to FIG. 9C are schematic views illustrating the first pattern used in the processing of the image display device according to the first embodiment;

FIG. 10A and FIG. 10B are schematic views illustrating another image display device according to the first embodiment;

FIG. 11 is a flowchart illustrating an operation of an image display device according to a second embodiment;

FIG. 12A to FIG. 12C are schematic views illustrating the second pattern used in the processing of the image display device according to the second embodiment;

FIG. 13 is a block diagram illustrating an image display device according to a third embodiment;

FIG. 14 is a block diagram illustrating the adjuster according to the third embodiment;

FIG. 15 is a flowchart illustrating the adjuster according to the third embodiment;

FIG. 16 is a flowchart illustrating the adjuster according to the third embodiment

FIG. 17A and FIG. 17B are schematic views illustrating the image display device according to the embodiment;

FIG. 18A and FIG. 18B are schematic views illustrating the image display device according to the embodiment;

FIG. 19A and FIG. 19B are schematic views illustrating the image display device according to the embodiment;

FIG. 20A and FIG. 20B are schematic views illustrating the image display device according to the embodiment;

FIG. 21A and FIG. 21B are schematic views illustrating the image display device according to the embodiment;

FIG. 22 illustrates an example of the system configuration of the image display device according to the embodiment; and

FIG. 23A to FIG. 23C are schematic views illustrating test patterns used in the processing of the image display device according to the fourth embodiment.

### DETAILED DESCRIPTION

According to an embodiment of the invention, an image display device that includes an optical part and a controller is provided. First input image data and second input image data are input to the controller. The controller causes the optical part to emit a first light based on first corrected image data of the first input image data having been corrected. The controller causes the optical part to emit a second light when receiving a signal employing first correction information of a relationship between the first input image data and the first corrected image data, wherein the second light is based on second corrected image data of the second input image data corrected based on the first correction information.

According to another embodiment of the invention, an image processing device including a controller is provided. First input image data and second input image data are input to the controller. The controller outputs a first corrected image data of the first input image data having been corrected. The controller outputs second corrected image data when receiving a signal employing first correction information. The first correction information is of a relationship between the first input image data and the first corrected image data. The second corrected image data is of the second input image data corrected based on the first correction information.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

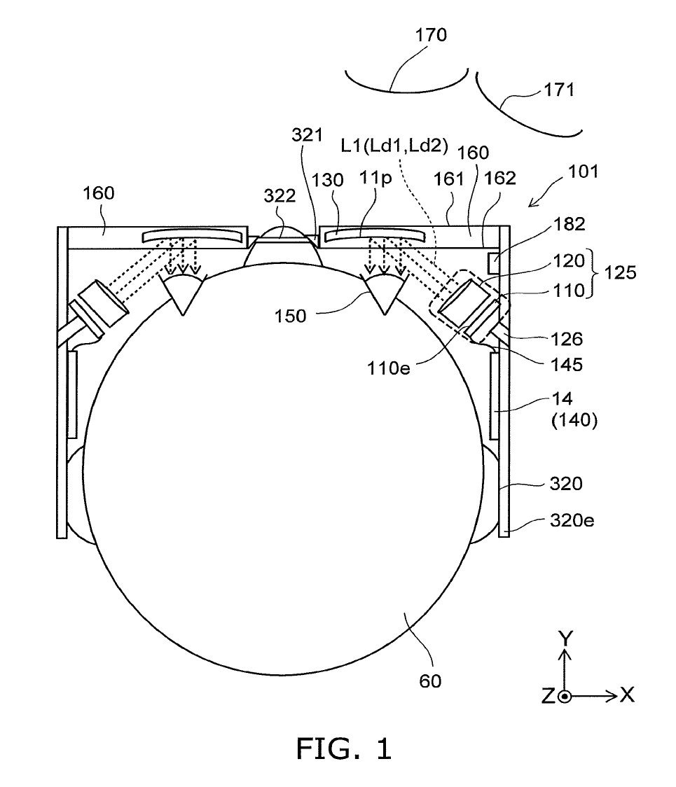

FIG. 1 is a schematic view illustrating an image display device according to a first embodiment.

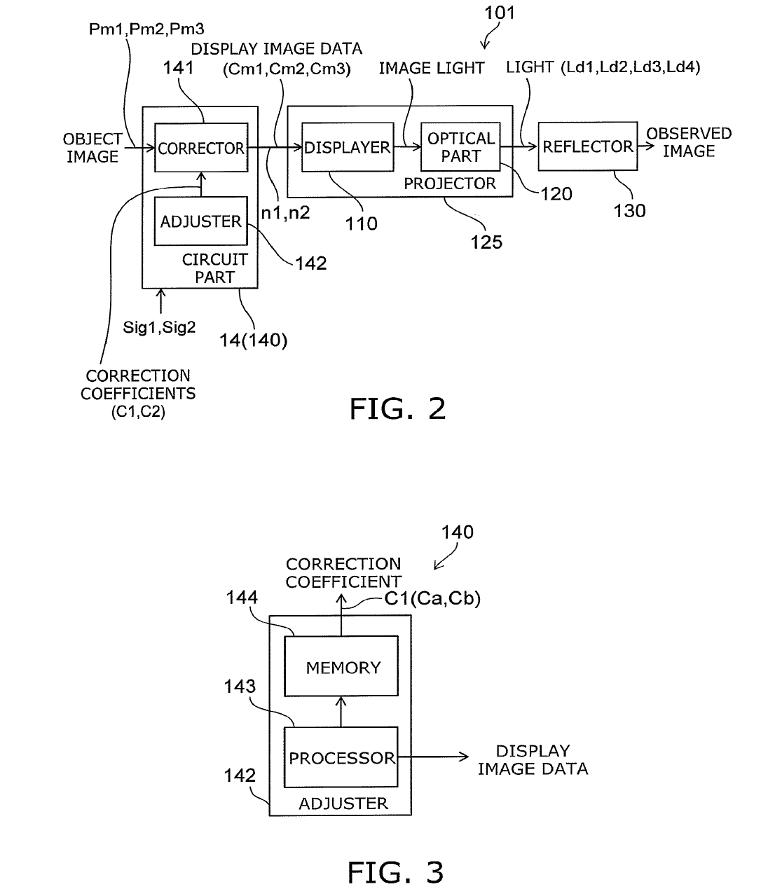

FIG. 2 is a block diagram illustrating the image display device according to the first embodiment.

As illustrated in FIG. 1 and FIG. 2, the image display device 101 includes a projector 125 and a controller 14. The controller 14 includes a circuit part 140 (an image processing device). The projector 125 includes a displayer 110 and an optical part 120. In the example, the image display device 101 further includes a reflector 130, a holder 320, and a position controller 126.

The circuit part 140 is connected by a wired or wireless method to an external storage medium, network, etc., and receives image information. For example, as illustrated in FIG. 1, the circuit part 140 is electrically connected to the displayer 110 by a bendable cable 145. Data of a display image (a corrected image) is input from the circuit part 140 to the displayer 110.

The circuit part 140 includes a corrector 141 and an adjuster 142 (referring to FIG. 2). The adjuster 142 outputs a correction coefficient to the corrector 141. In the corrector 141, the corrected image is generated by applying distortion correction to the object image based on the correction coefficient; and the data of the display image (the corrected image) is input to the displayer 110.

The displayer 110 includes multiple pixels 110e. The multiple pixels 110e are provided to be arranged in a plane. The displayer 110 emits an image light L1 including image information. The displayer 110 is a display that displays an image. The light that includes the image information is emitted toward the optical part 120. The display includes, for example, a liquid crystal, an organic EL, liquid crystal on silicon (Liquid Crystal On Silicon), etc. However, the embodiment is not limited thereto.

The optical part 120 is provided between the displayer 110 and the reflector 130 in the optical path of the image light L1 emitted from the multiple pixels 110e of the displayer 110. The optical part 120 includes at least one optical element. The optical part 120 projects the image light L1 that is incident. The optical element can include a lens, a prism, a mirror, etc. For example, the optical part 120 changes the travel direction of at least a part of the image light L1. Thus, the projector 125 (the optical part 120) emits the image light including the image information toward the reflector 130. In the case where multiple optical elements are used, the multiple optical elements may not be disposed on a straight line. The emission direction of the image light emitted by the projector 125 with respect to the reflector 130 is adjustable.

The reflector 130 reflects at least a part of the image light L1 passing through the optical part 120. For example, the reflector 130 reflects the light passing through the optical part 120 toward a pupil 150 of a viewer 60 (a user) of the image display device. The light that is reflected by the reflector 130 forms an image 170 (an observed image) as a virtual image when viewed from the pupil 150. Thus, the viewer 60 can view the image.

The reflector 130 transmits a part of the light incident on the reflector 130 from the external environment. Thereby, the viewer 60 can view the external environment through the reflector 130. The reflector 130 is provided along a first surface 11p. For example, multiple fine reflective surfaces are disposed in parallel in the first surface 11p and used as the reflector 130. The first surface 11p may be a plane or a curved surface. Each of the reflective surfaces is, for example, a half mirror and reflects at least a part of the incident light. Each of the reflective surfaces is tilted with respect to the first surface 11p; and a level difference is formed between the reflective surfaces. The angles between the first surface 11p and the reflective surfaces are determined by the positional relationship between the assumed pupil 150 and the optical axis of the optical part 120. Thereby, for example, the reflection angle of the light can be adjusted. The reflector 130 has a Fresnel configuration formed of the multiple reflective surfaces and the multiple level differences.

However, in the embodiment, the reflector 130 is not limited to such a half mirror. A normal half mirror may be used as the reflector 130; and another member in which the reflection angle can be adjusted may be used similarly. Also, although an example in which a half mirror in which the reflectance and the transmittance are the same fraction is applied is described as an example, the embodiment is not limited to the same fraction. The material that is included in the reflective surface may be any material as long as the material transmits a part of the light and reflects a part of the light.

In the example, the image is displayed as a virtual image. However, the image may be displayed as a real image by separating the reflector 130 from the pupil 150.

In the example, the image 170 is displayed at the front of the pupil 150. However, the image may be displayed at the edge of the visual field of the viewer 60 such as an image 171. Thereby, the visual field of the viewer 60 is not obstructed.

In the example illustrated in FIG. 1, the image display device 101 is an eyeglasses-type image display device. The holder 320 is, for example, an eyeglasses frame (a temple, a temple). The image display device 101 is mountable to the head of the viewer 60 by the holder 320.

The image display device 101 further includes eyeglasses lenses 160. In the example, the holder 320 further includes nose pads 321 and a bridge 322. The bridge 322 connects one eyeglasses lens 160 and the other eyeglasses lens 160. The rim of the eyeglasses lens 160 (the frame holding the eyeglasses lens 160), etc., may be provided as necessary. Although a configuration similar to normal corrective eyeglasses is described in the application, the embodiment may have a configuration such as that in which the left and right lenses are formed as one body.

The eyeglasses lens 160 (the reflector 130) is held by the holder 320. For example, similarly to a normal eyeglasses frame, the angle between the holder 320 and the eyeglasses lens 160 may be changeable.

For example, the relative arrangement of the nose pad 321 and the eyeglasses lens 160 is fixed. The reflector 130 is included in the eyeglasses lens 160 (provided as one body with the eyeglasses lens 160). In other words, a combiner integrated-type eyeglasses lens 160 is used; and the relative positional relationship of the reflector 130 and the eyeglasses lens 160 is fixed.

The eyeglasses lens 160 has a first surface 161 and a second surface 162. The second surface 162 is separated from the first surface 161. The reflector 130 is provided between the first surface 161 and the second surface 162. The position of the reflector 130 is not limited to that recited above; for example, a configuration in which the reflector 130 is disposed on the second surface 162 may be used.

A binocular head mounted display (HMD) that uses two image display devices 101 is illustrated in FIG. 1. One image display device displays an image to the right eye of the viewer 60; and the other display device displays an image to the left eye. The embodiment may be a monocular HMD in which one image display device 101 is used and an image is displayed to one eye.

In the example, one circuit part 140 is provided for one image display device 101. In the case where two image display devices 101 are used, the circuit part 140 may be integrated as much as possible.

When using the image display device 101, the viewer 60 places the nose pads 321 on the nose and places one end 320e of the holder 320 on an ear. Thus, the position of the holder 320 and the relative position of the eyeglasses lens 160 (and the reflector 130) are regulated according to the positions of the nose and the ears of the viewer 60. When using the image display device 101, the relative arrangement of the reflector 130 with respect to the holder 320 is substantially fixed. The position of the pupil 150 with respect to the reflector 130 moves according to the eyeball movement.

The relative arrangement of the displayer 110 and the optical part 120 is fixed inside the projector 125 of FIG. 1. The relative arrangement of the displayer 110 and the optical part 120 may be changeable to the extent that the function of projecting the image is not lost. For example, the displayer 110 and the optical part 120 are mounted by a screw inside the projector 125. A configuration may be used in which the relative distance and/or the angle between the displayer 110 and the optical part 120 can be adjusted by adjusting the tightness of the screw. The distance to the virtual image when viewed by the viewer 60 can be changed by adjusting the distance between the displayer 110 and the optical part 120. For example, an image that was viewed 1 m in front of the face can be moved to 2 m in front.

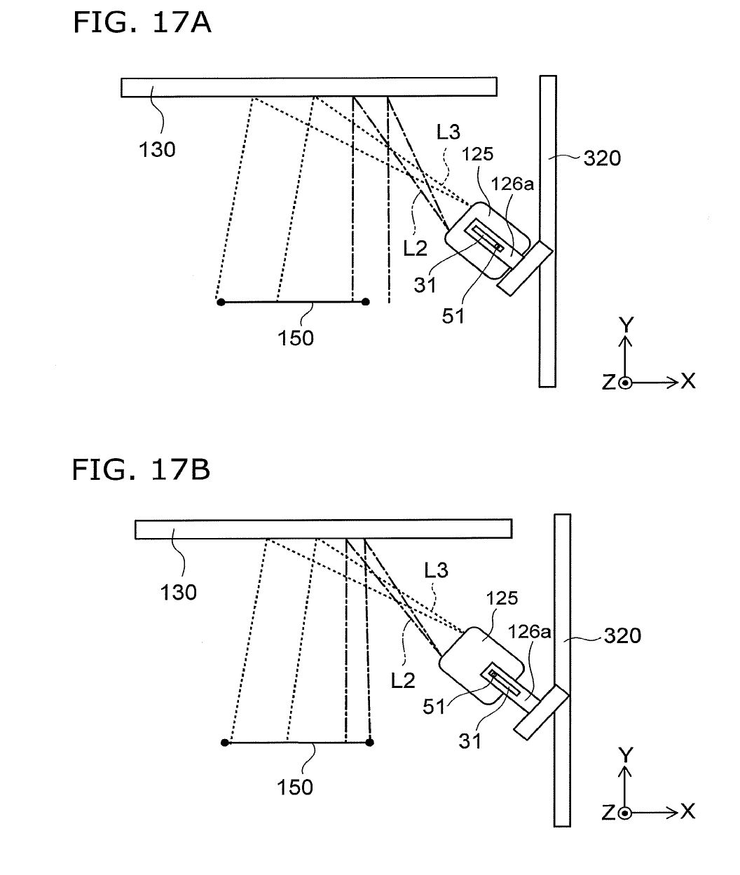

The projector 125 of FIG. 1 is held by the holder 320 via the position controller 126. The position controller 126 is fixed to the holder 320. The relative arrangement of the projector 125 and the reflector 130 is changeable by the position controller 126. For example, the position or the orientation of the projector 125 is modified by the position controller 126 rotating the projector 125. Thereby, the emission direction of the image light emitted by the projector 125 is adjusted. By the adjustment mechanism of the position controller 126 adjusting the pupil to be within the eye range, the viewer 60 can view a screen that is not partially lost. Specific examples of the position controller 126 (referring to FIG. 17A to FIG. 21B) are described below.

In FIG. 1, the direction in which the holder 320 extends is taken as a Y-axis direction. One direction perpendicular to the Y-axis direction is taken as an X-axis direction. A direction perpendicular to the X-axis direction and perpendicular to the Y-axis direction is taken as a Z-axis direction. For example, the X-axis direction corresponds to the left/right direction (the lateral direction) of the viewer 60; the Y-axis direction corresponds to the frontward/rearward direction of the viewer 60; and the Z-axis direction corresponds to the up/down direction (the vertical direction) of the viewer 60. Although the holder 320 has a side extending in a straight line configuration in the Y-axis direction in FIG. 1, the embodiment also includes the case where the configuration of the holder 320 curves gradually. The configuration of the holder 320 is modified appropriately by considering the designability and/or the convenience when using.

FIG. 3 is a block diagram illustrating the adjuster of the image display device according to the first embodiment.

FIG. 3 illustrates the adjuster 142 included in the circuit part 140 of the image display device 101.

At the startup of the image display device 101 or when a prescribed input is input to the circuit part 140 of the image display device 101, the adjuster 142 performs the processing causing the viewer 60 to select a correction coefficient (a correction table). Memory 144 that is included in the adjuster 142 stores the selected correction coefficient. When the image display device 101 displays the image, the adjuster 142 outputs the correction coefficient to the corrector 141. As illustrated in FIG. 2, the corrector 141 acquires the object image (the input image) which is the object to be displayed. Then, the corrector 141 generates a corrected image by performing a correction of the object image based on the correction coefficient output from the adjuster 142. The corrected image is an image for correcting the partial loss and/or distortion of the image viewed by the viewer. The corrector 141 outputs the generated corrected image to the displayer 110.

Subsequently, the displayer 110 displays the corrected image that is input and emits an image light toward the optical part 120. The optical part 120 emits, toward the reflector 130, corrected light in which the travel direction of at least a part of the light rays included in the image light incident on the optical part 120 is corrected. The reflector 130 reflects a part of the incident light; and the reflected light forms an image as the observed image when viewed from the pupil 150. Thus, in the embodiment, an easily-viewable observed image in which the optical distortion and/or partial loss are suppressed is displayed by the displayer 110 displaying the corrected image. Details of the correction processing are described below.

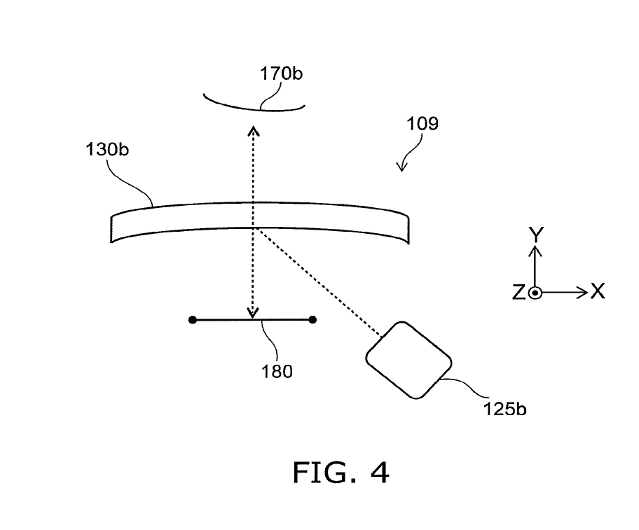

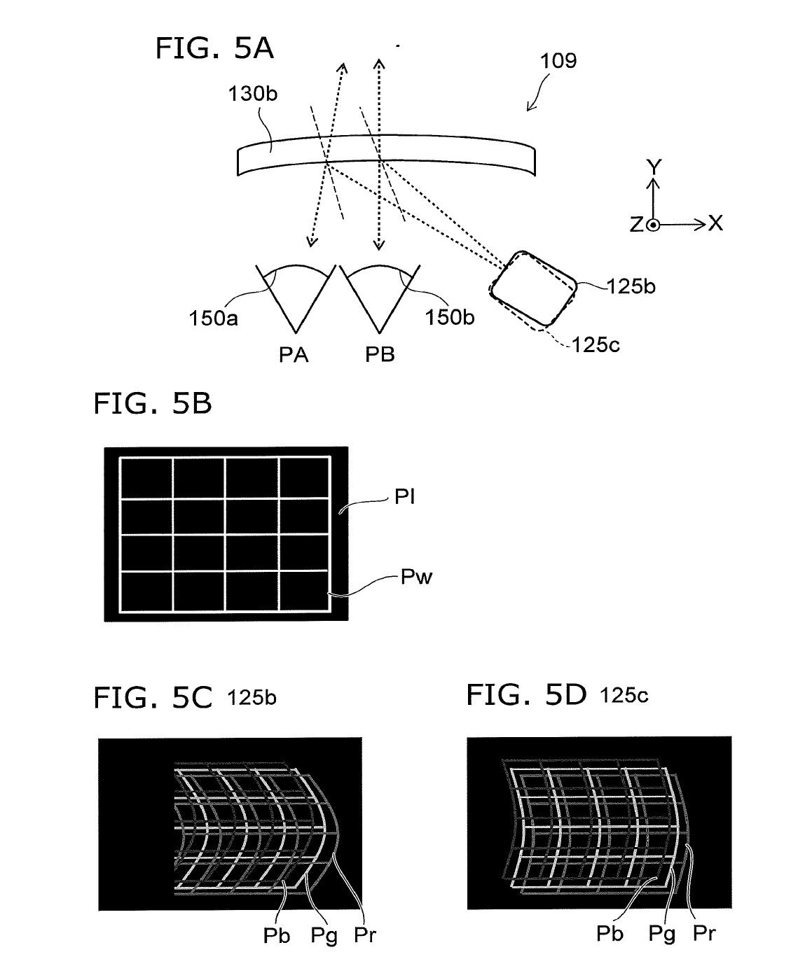

Partial loss, distortion, and color breakup of the image viewed by the viewer will now be described with reference to FIG. 4 and FIG. 5A to FIG. 5D.

FIG. 4 is a schematic view illustrating an image display device of a reference example.

The image display device 109 according to the reference example includes a reflector 130b and a projector 125b. A configuration similar to the reflector 130 is applicable to the reflector 130b; and a configuration similar to the projector 125 is applicable to the projector 125b. The image display device 109 differs from the image display device 101 according to the embodiment in that the circuit part 140 is not included. In other words, the correction processing of the object image described above is not performed in the image display device 109.

An image 170b (an observed image) is formed of the light emitted from the projector 125b. For example, in the image display device, the optical design is performed on the premise that the pupil of the viewer is positioned within a constant range. FIG. 4 illustrates that a range of the pupil position exists where the observed image 170b is observable. This range is called an eye range 180 and is a region having a diameter of about several millimeters.

In such an eyeglasses-type image display device, the position of the reflector 130 with respect to the position of the eye is determined according to the arrangement of the ears, the nose, and the eyes of the viewer 60. For example, when the viewer 60 changes, the position of the reflector 130 with respect to the eye changes. Therefore, when the viewer 60 changes, there are cases where the position of the image viewed by the viewer 60 changes; and the image is not displayed at the appropriate position. In the case where the pupil 150 is inside the eye range 180, the viewer can view the entire observed image 170b. However, in the case where the pupil 150 is outside the eye range 180, a partial loss of the screen occurs.

The light that includes image information and is emitted from the displayer travels toward the pupil via optical elements such as lenses, half mirrors, etc., included in the optical part and/or the reflector 130b. For example, aberration occurs each time the light passes through an optical element or each time the light is reflected by an optical element. Therefore, degradation such as optical distortion, color breakup, etc., occurs in the observed image 170b.

Optical distortion is an aberration when the light that is emitted from the displayer passes through the optical element. The optical distortion occurs when the image of the light passing through the optical element loses the resemblance to the image of the light emitted from the displayer.

In the display of the color image, color breakup is an aberration occurring due to the difference of the wavelengths of the light. The size of the image of the light after passing through the optical element is dependent on the wavelength of the light. For example, for shorter wavelengths, refraction due to the lens, etc., occurs more easily; and the eye range easily becomes narrow. For example, the center position of the image is dependent on the wavelength of the light and is different by color.

FIG. 5A to FIG. 5D are schematic views illustrating the image display device of the reference example.

FIG. 5A shows the state in which the light emitted from the projector 125b reaches a pupil 150a (a position PA). FIG. 5A shows the state in which the light emitted from a projector 125c reaches a pupil 150b (a position PB). The difference between the projector 125b and the projector 125c is due to the difference between the arrangements (the orientations) of the projector. For example, the difference between the pupil positions occurs due to individual differences between the viewers 60.

FIG. 5B is an example of an image PI displayed by the displayer of the image display device 109. The image PI includes an image Pw of a white square lattice. White is displayed by superimposing red, blue, and green.

FIG. 5C is an example of a virtual image viewed from the pupil 150a (the position PA) when the image PI is displayed by the displayer. FIG. 5D is an example of a virtual image viewed from the pupil 150b (the position PB) when the image PI is displayed by the displayer.

As illustrated in FIG. 5C and FIG. 5D, the shape of the displayed virtual image is distorted with respect to the shape of the image PI. This is caused by the phenomena occurring due to the optical distortion and/or the color breakup described above. Further, due to the color breakup, the sizes and/or the positions are different from each other for a region Pb where blue is displayed, a region Pg where green is displayed, and a region Pr where red is displayed; and it can be confirmed that the displayable region is different by color. In FIG. 5C, a part of the virtual image at the left edge is partially lost. This is the phenomenon occurring in the case where the position PB exists outside the eye range 180 of the image display device 109.

Thus, distortion occurs in the displayed image according to the relative arrangement of the pupil and the projector. Further, partial screen loss occurs in the case where the pupil exists outside the eye range.

Conversely, in the embodiment, the circuit part 140 performs the processing of causing the viewer 60 to select the correction coefficient. Then, the observed image is displayed by using the corrected image generated based on the selected correction coefficient. Thereby, the display can be adjusted to an easily-viewable state for each viewer.

Details of the correction processing will now be described.

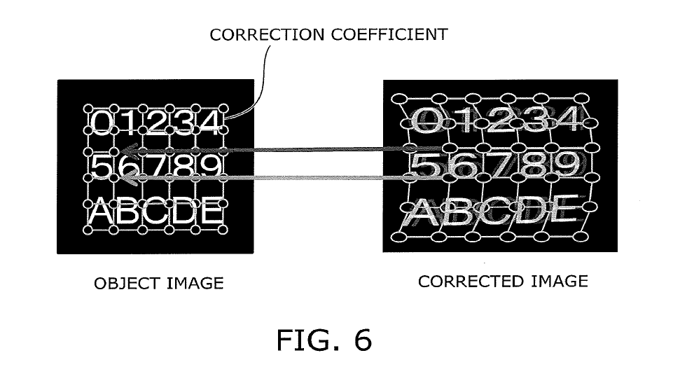

FIG. 6 is a schematic view illustrating image processing of the image display device according to the first embodiment.

FIG. 6 illustrates the processing of correcting the object image based on the correction coefficient and generating the corrected image. As illustrated in FIG. 6, the correspondences between each pixel of the corrected image and each pixel of the object image are stored in the correction coefficient. The corrector 141 acquires the positions of the pixels of the object image corresponding to the corrected image by referring to the correspondences and generates the corrected image.

The distortion is different between the colors in the case where the object image is, for example, an image illustrated using three primary colors such as red, green, blue, etc. In such a case, the corrected image is generated using the three correction coefficients set for each color.

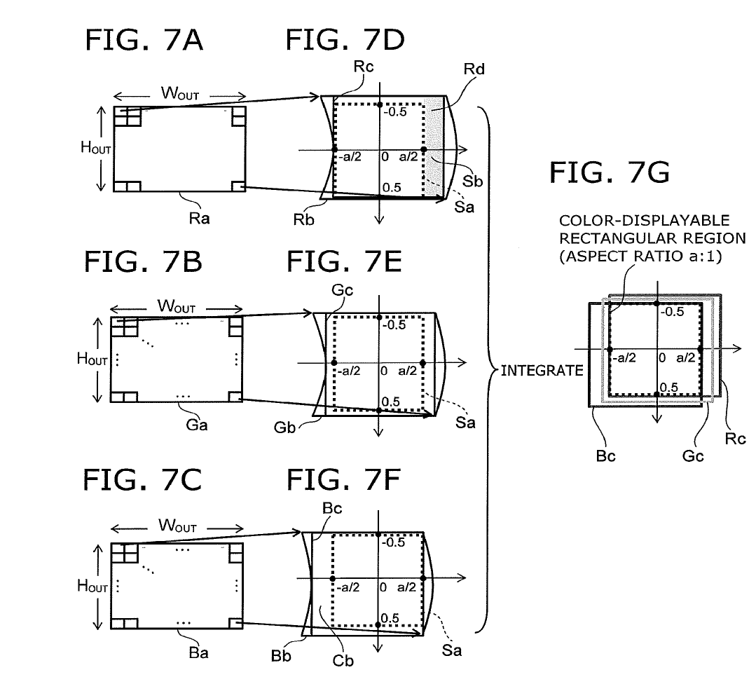

FIG. 7A to FIG. 7G are schematic views illustrating the correction coefficients used in the image display device according to the first embodiment.

When setting the correction coefficients, for example, the observed image is imaged using a camera. The correction coefficients can be determined from the correspondences between each pixel of the observed image and each pixel of the corrected image. In the case where the object image and the corrected image are images illustrated using three primary colors such as red, green, blue, etc., the correspondences of the pixels are stored for each color.

FIG. 7A shows an image Ra illustrated by a first color (in the example, red “R”) of the corrected image. For example, the image is generated from first color pixels of the object image.

FIG. 7B shows an image Ga illustrated by a second color (in the example, green “G”) of the corrected image. For example, the image is generated from second color pixels of the object image.

FIG. 7C shows an image Ba illustrated by a third color (in the example, blue “B”) of the corrected image. For example, the image is generated from third color pixels of the object image.

The observed image that is viewed by the viewer 60 includes multiple color images corresponding to multiple color components. For example, the observed image is the superimposition of a first color image corresponding to the first color pixels, a second color image corresponding to the second color pixels, and a third color image corresponding to the third color pixels.

FIG. 7D shows a first color image Rb formed of red light including the information of the image Ra of FIG. 7A.

FIG. 7E shows a second color image Gb formed of green light including the information of the image Ga of FIG. 7B.

FIG. 7F shows a third color image Bb formed of blue light including the information of the image Ba of FIG. 7C.

As described above, the correspondence between the observed image and the corrected image is different between the colors due to the effect of the color breakup. For example, as illustrated in FIG. 7D to FIG. 7F, the regions where the first to third color images are displayed are different from each other. In the viewed image, although a color display is possible in the region where the first to third color images overlap each other, the color display is not possible in the other regions. Therefore, the display regions of the three primary color are integrated into a color-displayable region. As shown in FIG. 7D to FIG. 7F, inscribed rectangles Rc, Gc, and Bc of the reference position regions of the colors are determined. Also, the product region of the inscribed rectangles is determined as shown in FIG. 7G. The reference position of each color is normalized by the size of the product region. Thereby, the correction coefficients are generated so that the region (the aspect ratio a:1) where color is displayable can be referred to.

The aspect ratio a:1 is stored in the correction coefficients. For example, the correction coefficients include information relating to an overlapping region Sa (the product region) inside the viewed image where the multiple color images (the first to third color images) overlap each other. Specifically, the correction coefficients include the information of the ratio (a:1) of the length along the lateral direction of the overlapping region Sa and the length along the vertical direction of the overlapping region Sa. Thereby, for example, the aspect ratio of the object image can be maintained when correcting the distortion.

By the processing recited below, the correspondences between the coordinate positions in the corrected image and the positions in the normalized coordinates are obtained for each of the three colors of RGB.

Other than the color-displayable region, the regions where the three colors cannot be represented simultaneously may be defined as regions where a single color or two colors are displayable. The correction coefficients may include information of regions where a single color or two colors are displayable. In other words, for example, the correction coefficients may further include information relating to a non-overlapping region Sb inside the viewed image where multiple color images (the first color image and the second color image) do not overlap each other.

For example, in the case of red, other than the color-displayable region, the information of a region Rd where the display of a single color is possible may be stored in the correction coefficient as shown in FIG. 7D. The correction coefficient may include information of a region where a single color other than red is displayable, or information of a region where a combination of two colors is displayable.

The correction coefficients may include parameters of curve representations. Thereby, the correspondence between the pixels of the corrected image and the pixels of the observed image can be calculated.

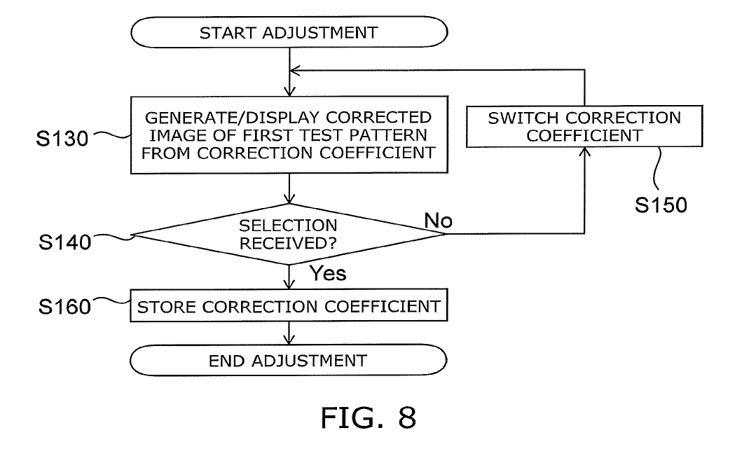

FIG. 8 is a flowchart illustrating an operation of the image display device according to the first embodiment.

FIG. 8 shows the processing of the circuit part 140 (the controller 14) causing the viewer 60 to select the correction coefficients. As illustrated in FIG. 8, the circuit part 140 executes first processing (steps S130, S140, and S150) at the startup of the image display device 101 or when a prescribed input is input to the image display device 101.

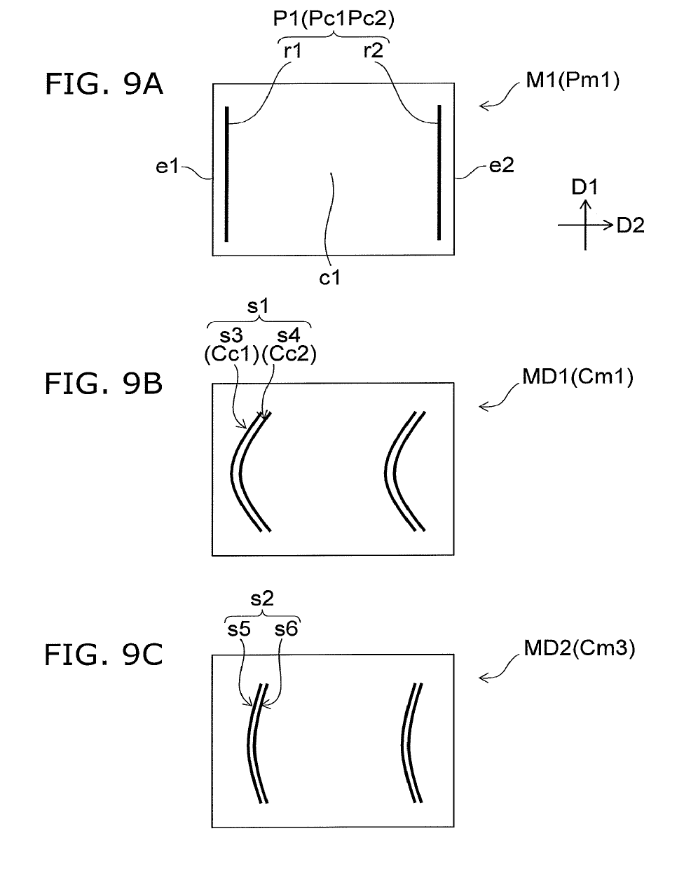

In step S130, the adjuster 142 generates a display image based on a first pattern (a first test pattern) based on the correction coefficients. For example, the image that is generated is output as image data from a processor 143 to the displayer 110 as illustrated in FIG. 3. The first pattern, the display image, etc., are described below (referring to FIG. 9A to FIG. 9C).

For example, the circuit part 140 (the memory 144 of the adjuster 142) pre-stores the multiple correction coefficients (e.g., a first correction coefficient (first correction information C1) and a second correction coefficient (second correction information C2)). The number of correction coefficients may be any number of two or more. The appropriate correction coefficients are different according to the pupil position of the viewer 60 and/or the arrangement of the projector. Therefore, each of the multiple correction coefficients stored in the memory 144 may be determined to correspond to the positional relationship between the projector 125 and the reflector 130. Or, each of the multiple correction coefficients stored in the memory 144 may be determined to correspond to the positional relationship between the projector 125 and the pupil of the viewer 60. Each of the multiple correction coefficients may be determined for each individual entity of the image display device 101 by considering the individual differences (the manufacturing fluctuation, etc.) of the image display device 101. The memory 144 may store one correction coefficient that is calculated from the multiple correction coefficients and used as a reference.

When step S130 is first performed, the adjuster 142 selects one of the multiple correction coefficients stored in the memory 144 and generates the display image (the corrected image) based on the selected correction coefficient. The selected correction coefficient may be the initial or final correction coefficient in the registration order or may be a prescribed correction coefficient to be used as the reference.

The information of the position of the projector 125 or the information of the pupil position of the viewer may be acquired as the reference of selecting the one of the stored correction coefficients.

For example, in the case where a mechanical mechanism that adjusts the position of the projector 125 in stages is included in the position controller 126 and a scale, etc., illustrating the position of the projector 125 is provided, the viewer 60 is caused to input information corresponding to the value of the scale to the circuit part 140. The correction coefficient may be selected based on this information. Or, the position controller 126 may be caused to sense the position of the projector 125. Any sensor such as a camera, a potentiometer, etc., can be used to sense the position of the projector 125. The correction coefficient may be selected based on the sensed position information.

For example, the image display device 101 further includes a sensor 182 that senses the pupil position (referring to FIG. 1). For example, the sensor 182 is provided at the holder 320. The sensor 182 may include any sensor such as an infrared sensor, a visible light camera, etc. The pupil position can be measured (estimated) based on the information of the image, etc., obtained from the sensor. An eye potential, etc., may be utilized to measure the pupil position. For example, the change of the eye potential when light is incident on the pupil 150 is measured. Information relating to the pupil position can be obtained based on the incident direction of the light and/or the change of the eye potential.

Projector position information may be used to estimate the pupil position of the viewer 60. For example, in an eyeglasses-type display device, the relative arrangement of the reflector 130 and the optical part 120 changes according to the arrangement of the ears, the nose, the eyes, etc., of the viewer 60. Therefore, it is also possible to somewhat estimate the pupil position of the viewer 60 based on the information of the relative arrangement of the optical part 120 and the reflector 130.

For example, in the case where step S130 is first executed, the adjuster 142 generates a first display image (first corrected image data Cm1) by correcting a first image (first input image data Pm1) including a first pattern based on the first correction coefficient.

The first correction coefficient is one of the multiple correction coefficients stored in the memory 144 or a correction coefficient calculated from the multiple correction coefficients stored in the memory 144. Then, the circuit part 140 (the controller 14) causes the projector 125 to emit the light (a light Ld1) including the image information of the generated first display image as the image light.

In other words, the adjuster 142 transmits, to the projector 125, the corrected image data (the first corrected image data Cm1) of the input image data (the first input image data Pm1) for the test having been corrected. The projector 125 emits the first light (the light Ld1) based on the first corrected image data Cm1.

Thereby, the first display image (the first corrected image data Cm1) is displayed to the viewer 60. The first image before the correction may be stored in the memory 144, etc., or may be input from the outside.

The viewer 60 can input, to the circuit part 140, a signal selecting the first correction coefficient (the first display image) based on the displayed image. In step S140, the circuit part 140 receives the selection of the correction coefficient from the viewer 60. In other words, for example, the circuit part 140 receives a signal Sig1 employing the first correction information of the relationship between the first input image data and the first corrected image data. Step S160 is executed in the case where the circuit part 140 receives the signal selecting the first correction coefficient (the signal employing the first correction information). Step S150 is executed in the case where the circuit part 140 does not receive the signal selecting the first correction coefficient in step S140.

A method in which the viewer 60 inputs, to the image display device 101, information relating to whether or not the correction coefficient is selected (e.g., a code indicating the end of step S140, etc.) is an example of a method for the circuit part 140 receiving the selection of some correction coefficient. For example, software (an application) is installed in a computer and/or a portable terminal; and the information is input from the viewer 60 to the circuit part 140 via the computer, the portable terminal, etc.

In step S150, the circuit part 140 switches the correction coefficient that is currently used to another correction coefficient. Then, the circuit part 140 again executes step S130 using the switched correction coefficient.

A method in which the viewer 60 inputs, to the image display device, the information instructing a switch of the correction coefficient is an example of the method for the circuit part 140 switching the correction coefficient. For example, software (an application) is installed in a computer and/or a portable terminal; and information is input from the viewer 60 to the circuit part 140 via the computer, the portable terminal, etc.

The information (e.g., the information of the position of the projector 125, the information of the pupil position of the viewer 60, etc., acquired in step S130 of the first time may be used to switch the correction coefficient in step S150. The correction coefficient that is selected or generated in step S150 is used in step S130 of the second or subsequent times.

When switching the correction coefficient used to generate the display image, for example, “a: the correction corresponding to the arrangement of the projector,” “b: the correction corresponding to the pupil position,” or “c: the correction corresponding to the individual difference of the image display device” is performed. The correction coefficient may be switched by combining at least two of the three of a to c.

“a: the correction corresponding to the arrangement of the projector” can be performed in the case where the correction coefficient is stored for each arrangement of the projector 125. In such a case, for example, the correction coefficient that corresponds to the arrangement of the projector 125 is generated by a linear interpolation method such as a bilinear interpolation from the multiple correction coefficients stored in the memory 144, etc. For example, a single-axis bar or the like is displayed; and the viewer 60 inputs, to the image display device, an input value indicating the position of the projector 125. The adjuster 142 generates the correction coefficient by a linear interpolation method corresponding to the input value. Or, the viewer 60 may input, to the image display device, information indicating the rotational position of the projector 125. Or, the memory 144 may switch the stored multiple correction coefficients in order. In the case where the correction coefficients are stored for each position of the pupil of the viewer 60, “b: the calculation of the correction coefficient corresponding to the pupil position” can be performed. In such a case, the correction coefficient can be switched by a processing similar to the case of “a: the correction corresponding to the arrangement of the projector.” In the case where the correction coefficient is stored for each individual difference of the image display devices, “c: the correction corresponding to the individual difference of the image display device” is performed. In such a case, the multiple correction coefficients that are stored in the memory 144 are switched in order.

For example, in step S150, the circuit part 140 switches the first correction coefficient described above to the second correction coefficient. The second correction coefficient is one of the multiple correction coefficients stored in the memory 144 or a correction coefficient calculated from the multiple correction coefficients stored in the memory 144. Subsequently, in step S130, the circuit part 140 generates a second display image (third corrected image data Cm3) by correcting the first image (the first input image data Pm1) described above based on the second correction coefficient. Then, the circuit part 140 causes the projector 125 to emit the light (a light Ld2) including the image information of the generated second display image as the image light.

In other words, the adjuster 142 transmits, to the projector 125, the corrected image data (the third corrected image data Cm3) of the input image data (the first input image data Pm1) for the test having been corrected. The projector 125 emits the third light (the light Ld2) based on the third corrected image data Cm3. The third corrected image data Cm3 is different from the first corrected image data Cm1.

Thereby, the second display image (the third corrected image data Cm3) is displayed to the viewer 60. The viewer 60 can input, to the circuit part 140, the signal of selecting the second correction coefficient (the second display image) based on the displayed image. In other words, for example, the circuit part 140 can receive a signal Sig2 employing the second correction information C2 of the relationship between the first input image data Pm1 and the third corrected image data Cm3.

Thus, the viewer 60 is caused to select one of the display images (the correction coefficients) by repeating steps S130 to S150. For example, the viewer 60 selects a display image in which the distortion, etc., are corrected appropriately.

The circuit part 140 stores first information relating to the relationship between the selected one of the display images and the first image before the correction. The first information includes, for example, the correction coefficient used to generate the selected display image.

In step S160, the memory 144 stores the first information. For example, in the case where the first display image is selected, the memory 144 stores the first correction coefficient.

Thus, the viewer 60 can easily adjust the display to an easily-viewable state.

Subsequently, when the image display device 101 performs the display, the corrector 141 generates the corrected image in which the object image (the input data) is corrected based on the first information (the selected correction coefficient); and light that includes the image information of the corrected image is emitted from the projector 125.

For example, in step S140, the image display device 101 performs a display based on the first correction information C1 in the case where the viewer 60 selects the first display image and the circuit part 140 receives the signal Sig1 employing the first correction information C1 of the relationship between the first input image data Pm1 and the first corrected image data Cm1. In such a case, the circuit part 140 transmits, to the projector 125, corrected image data (second corrected image data Cm2) of input data (second input image data Pm2) corrected based on the first correction information C1. The projector 125 emits a second light (a light Ld3) based on the second corrected image data.

FIG. 9A to FIG. 9C are schematic views illustrating the first pattern used in the processing of the image display device according to the first embodiment.

FIG. 9A shows an image (a first image M1) including the first pattern P1. The first image M1 includes multiple pixels. The pixels that are included in the first image M1 include two or more multiple color components.

In the example illustrated in FIG. 9A, the first pattern P1 includes a first element r1 and a second element r2. For example, the first element r1 and the second element r2 each are substantially rectangular images (patterns) extending in a first direction D1 inside the first image M1. In other words, the length of the first element r1 along the first direction D1 is longer than the length of the first element r1 along a second direction D2 perpendicular to the first direction D1.

The first element r1 is positioned on the left side (e.g., the left edge) of the first image M1. In other words, inside the first image M1 illustrated in FIG. 9A, the distance between a first side e1 and the first element r1 is shorter than the distance between a second side e2 and the first element r1. The first side e1 and the second side e2 are sides of the first image M1 separated from each other in the second direction D2. The second element r2 is positioned on the right side (e.g., the right edge) of the first image M1. In other words, inside the first image M1, the distance between the second side e2 and the second element r2 is shorter than the distance between the first side e1 and the second element r2.

The color of the first element r1 and the color of the second element r2 each are represented by two or more primary colors of the primary colors used in the displayer 110. For example, in the case where the three colors of red, green, and blue are used in the displayer 110, the color of each rectangle can be set to magenta in which red and blue are combined (superimposed).

The primary colors that are used in the displayer 110 are the colors of the light emitted by the subpixels included in the pixels 110e of the displayer 110. For example, each of the pixels 110e includes a first subpixel that emits light of the first color (e.g., red), a second subpixel that emits light of the second color (e.g., green), and a third subpixel that emits light of the third color (e.g., blue). A color image is displayed by superimposing the light of the three colors.

FIG. 9B shows a display image (a first display image MD1) generated using the first correction coefficient from the first image M1. FIG. 9C shows a display image (a second display image MD2) generated using the second correction coefficient from the first image M1. The first display image MD1 (the first corrected image data) includes a first image s1 in which the first element r1 is corrected. The second display image MD2 (the third corrected image data) includes a second image s2 in which the first element r1 is corrected.

As described in reference to FIG. 6 and FIG. 7A to FIG. 7G, because the distortion is different for each color, the correction coefficient has a component corresponding to each color. Then, the circuit part 140 generates the first display image MD1 and the second display image MD2 by converting the coordinates of each pixel included in the first image M1 for each color component. Therefore, the first image s1 includes an image s3 (a third image) of the first color based on the first pattern P1 and an image s4 (a fourth image) of the second color based on the first pattern P1. Also, the second image s2 includes an image s5 (a fifth image) of the first color based on the first pattern P1 and an image s6 (a sixth image) of the second color based on the first pattern P1. In the illustrated example, the image s3, the image s4, the image s5, and the image s6 each are images in which the first element r1 is corrected.

As described above, the color breakup and/or the distortion of the observed image are different according to the pupil position of the viewer 60 and/or the arrangement of the projector 125. Therefore, a difference between the correction results occurs according to the correction coefficient. In other words, for example, the shape of the image s1 illustrated in FIG. 9B is different from the shape of the image s2 illustrated in FIG. 9C. For example, the width along the second direction D2 of the image s1 is different from the width along the second direction D2 of the image s2. Also, the positional relationship (e.g., the spacing or the overlap) between the image s3 and the image s4 in the first display image MD1 is different from the positional relationship between the image s5 and the image s6 in the second display image MD2.

Thus, the circuit part 140 corrects the input image for each color component. In other words, for example, the first correction information C1 (the first correction coefficient) includes first color correction information Ca that corrects the component of the first color, and second color correction information Cb that corrects the component of the second color. The first color correction information Ca is different from the second color correction information Cb. The first image M1 is a superimposition of the image of the first color and the image of the second color. That is, the first input image data Pm1 of the first image M1 includes first color input image data Pc1 of the image of the first color and second color input image data Pc2 of the image of the second color. Also, the first corrected image data Cm1 of the first display image MD1 includes first color corrected image data Cc1 relating to the first color and second color corrected image data Cc2 relating to the second color. The first color corrected image data is data in which the first color input image data is corrected using the first color correction information; and the second color corrected image data is data in which the second color input image data is corrected using the second color correction information. In other words, the first color correction information Ca is of the relationship between the first color input image data Pc1 and the first color corrected image data Cc1; and the second color correction information Cb is of the relationship between the second color input image data Pc2 and the second color corrected image data Cc2.

As described above, the image display device 101 according to the embodiment displays the multiple display images (the first and second display images MD1, MD2, etc.) corresponding to mutually-different color breakup, etc. Thereby, the processing of causing the viewer 60 to select the correction coefficient is performed. Thereby, the viewer 60 can easily adjust the display to an easily-viewable state.

For example, a method for suppressing the color breakup and/or the distortion by adjusting the optical design of the reflector 130 and/or the optical part 120 also may be considered. However, in the case where the image light is projected from the side of the viewer 60 as in the image display device 101, the degrees of freedom of the optical design easily become limited. Therefore, an easily-viewable display may not be obtained only by the adjustment of the optical design. Also, there are cases where it is difficult to adjust the optical design for each user. Conversely, in the embodiment, the viewer 60 is caused to select a correction coefficient; and a corrected image is generated using the selected correction coefficient. Thereby, the viewer 60 easily obtains an easily-viewable display.

In the case where the image light is projected from the side of the viewer 60 as in the image display device 101, the distortion on the left side and the distortion on the right side may be different in the observed image viewed by the viewer 60. Conversely, the first pattern P1 illustrated in FIG. 9A includes the first element r1 disposed on the left side of the image and the second element r2 disposed on the right side of the image. Thereby, the viewer 60 can compare the distortion on the left and right and can adjust the display to a more easily-viewable state.

The distortion at the edge part of the observed image easily becomes larger than the distortion at the central part of the observed image. Therefore, it is desirable for the first element r1 and the second element r2 to be proximal to the edge parts of the first image M1. In other words, the distance between the first element r1 and the side e1 is shorter than the distance between the first element r1 and a center c1. Also, the distance between the second element r2 and the side e2 is shorter than the distance between the second element r2 and the center c1. Thereby, the adjustment of the display can be performed easily.

It is desirable for the first pattern (the first direction D1 in which the rectangles extend and the second direction D2 in which the two rectangles are arranged) to be determined based on the relative arrangement of the projector 125 and the reflector 130. For example, in the case where the image light travels along the X-Y plane as in FIG. 1, in the virtual image (the observed image) displayed to the viewer 60, the distortion in the horizontal direction (the X-axis direction) is larger than the distortion in the vertical direction (the Z-axis direction). Therefore, the first pattern is determined to easily visually confirm the distortion in the horizontal direction.

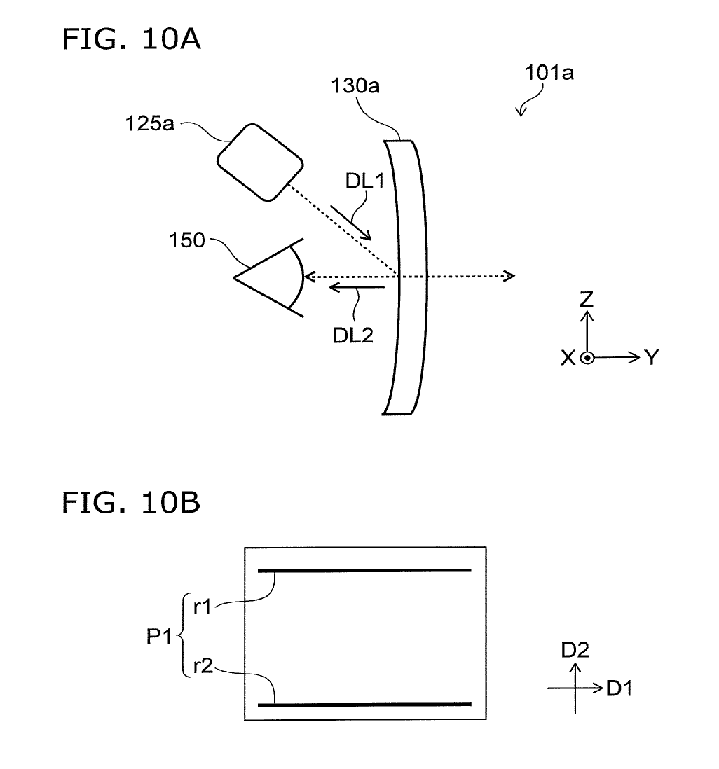

The shape of the first pattern may be changed according to the relative arrangement of the projector 125 and the reflector 130. This will now be described with reference to FIG. 10A and FIG. 10B.

FIG. 10A and FIG. 10B are schematic views illustrating another image display device according to the first embodiment. The image display device 101a illustrated in FIG. 10A includes a projector 125a and a reflector 130a. The projector 125a is positioned higher than the pupil 150 of the viewer 60. The projector 125a emits the image light toward the reflector 130a from a position higher than the pupil 150. The image light travels in an incident direction DL1 and is incident on the reflector 130a. The reflector 130a reflects the image light; and the reflected image light travels in a reflection direction DL2 and is incident on the pupil 150. Otherwise, a description similar to that of the image display device 101 described in reference to FIG. 1 is applicable to the image display device 101a

In the example, the plane that includes the incident direction DL1 and the reflection direction DL2 is the Z-Y plane.

In such a case, in the virtual image displayed to the viewer 60, the distortion in the vertical direction is larger than the distortion in the horizontal direction. At this time, a first pattern such as that illustrated in FIG. 10B is used to select the correction coefficient used in the correction of the distortion. In the first pattern illustrated in FIG. 10B, the first direction D1 in which the first element r1 extends corresponds to the horizontal direction (the X-axis direction); and the second direction D2 from the first element r1 toward the second element r2 corresponds to the vertical direction (the Z-axis direction).

Thus, in the virtual image when viewed by the viewer 60, it is desirable for the first direction D1 to be a direction perpendicular to a plane including the incident direction and the reflection direction of the reflector 130 for the image light (the light ray at the center of the luminous flux). In the virtual image when viewed by the viewer 60, it is desirable for the second direction D2 to be a direction parallel to a plane including the incident direction and the reflection direction of the reflector 130 for the image light. Thereby, the distortion and/or the color breakup can be confirmed easily; and the adjustment of the display can be performed easily.

The first patterns shown in FIG. 9A and FIG. 10B are shown as examples and may not always match the actual test patterns. For example, the widths and the heights of the rectangles are arbitrary. Two or more rectangles may be included in the first pattern. It is unnecessary for the background to be white; and the background may be black or another color. Text for adjusting the image may be included.

### Second Embodiment

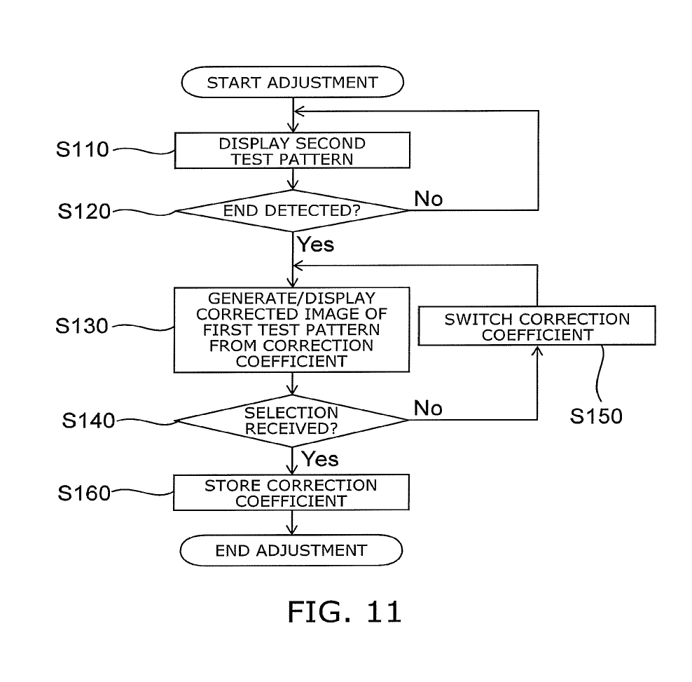

FIG. 11 is a flowchart illustrating an operation of an image display device according to a second embodiment.

Similarly to the image display device 101 according to the first embodiment, the image display device according to the second embodiment includes the controller 14 (the circuit part 140), the projector 125, the reflector 130, etc. The processing of the circuit part 140 of the second embodiment is different from that of the first embodiment. Otherwise, a description similar to that of the first embodiment is applicable to the second embodiment.

FIG. 11 shows the processing of the circuit part 140 causing the viewer 60 to select the correction coefficient. In the second embodiment as illustrated in FIG. 11, the circuit part 140 performs second processing (steps S110 and S120) before the first processing (steps S130, S140, and S150) is performed. Steps S130, S140, and S150 are similar to those described in the first embodiment. In this specification, the terms first, second, etc., do not indicate the order of the processing in the image display device unless otherwise indicated.

For example, third input image data Pm3 that includes information of a second pattern (a second test pattern) is input to the circuit part 140.

In step S110, the circuit part 140 causes the optical part 120 to emit a light Ld4 including image information n1 of a display image (a third display image MD3) based on the third input image data. Also, for example, the light includes information n2 of an instruction image instructing the viewer to use the third display image MD3 to change at least one of the relative arrangement of the optical part 120 and the reflector 130, the relative arrangement of the optical part 120 and the eye of the viewer 60, or the relative arrangement of the reflector 130 and the eye of the viewer 60. For example, the instruction is provided to the viewer by text or an illustration.

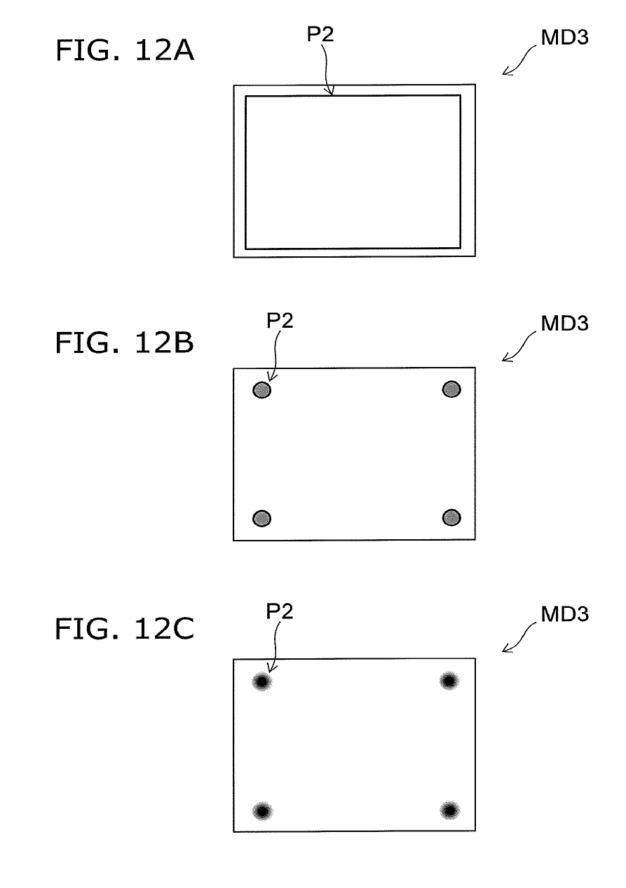

FIG. 12A is a schematic view illustrating the third display image MD3 including a second pattern P2. The second pattern P2 is an image indicating the position of at least a part of the outer perimeter (the outermost perimeter) of the third display image MD3. In the example of FIG. 12A, the second pattern P2 surrounds the central part of the third display image MD3 and is a rectangular shape (a frame-like shape) along the outer perimeter of the third display image MD3. The color of the second pattern P2 is one of the primary colors used in the displayer 110. For example, the color of the second pattern P2 is one of red, green, or blue, and is green in the example.

The second pattern P2 may be a pattern indicating the four corners of the third display image MD3 as illustrated in FIG. 12B and FIG. 12C. Four circles that are disposed at the four corners are used as the pattern indicating each of the four corners. In FIG. 12B, the color of the second pattern P2 is, for example, green. In FIG. 12C, the color of the second pattern P2 is not a primary color; and the gradation changes continuously according to the distance from the center of each circle.

The second patterns P2 shown in FIG. 12A to FIG. 12C are shown as examples and may not always match the actual test patterns. For example, the width of the outer frame in FIG. 12A may be any size; and the color of the second pattern P2 may be black instead of a primary color. The radius of the circle in FIG. 12B and FIG. 12C may be any size; and the shape of the symbol indicating the four corners may not be a circle and may be any shape. In FIG. 12A to FIG. 12C, it is unnecessary for the background to be white; the background may be black or another color; and text for adjusting the image may be included. Also, similarly to step S130 described above, the correction coefficient to be used as the reference may be prepared; and a third display image may be generated and displayed as the corrected image of the second pattern based on the correction coefficient.

The viewer 60 can perform the adjustment of the partial screen loss (the adjustment of the eye range) while referring to the observed image displayed in step S110. In step S120, the circuit part 140 detects the end of step S110. In the case where the circuit part 140 detects the end of step S110 in step S120, the circuit part 140 executes the processing of step S130. A method in which the viewer 60 inputs information indicating the end of step S110 (e.g., a code indicating the end of step S110, etc.) to the image display device is an example of the method by which the circuit part 140 detects the end of step S110. For example, software (an application) is installed in a computer and/or a portable terminal; and the information is input from the viewer 60 to the circuit part 140 via the computer, the portable terminal, etc.

As described in reference to FIG. 1, the emission direction of the image light can be adjusted by the projector 125 being rotated by the position controller 126. For example, the viewer 60 is caused to adjust the rotation angle of the projector 125 in step S110 to adjust the partial screen loss. The position controller 126 may include a mechanical mechanism that adjusts the position of the projector 125 in stages. For example, a scale such as a dial, etc., indicating the position information is provided; and a mechanism that adjusts the position of the projector 125 in stages may be used. It is sufficient for the method in which the viewer 60 adjusts the partial screen loss to be a method in which the relative arrangement of the pupil position of the viewer 60 with respect to the reflector 130 can be adjusted; and the rotation of the projector 125 may not always be used. For example, a method may be used in which nose pads 321 having a different configuration are replaced.

For example, the positional relationship between the projector 125 and the pupil 150 changes according to individual differences such as the shape of the head of the viewer 60, etc. Therefore, partial screen loss may occur when the user of the image display device changes. Conversely, according to the embodiment, the partial loss can be suppressed by the adjustment of the position of the projector 125 by executing step S110.

As described above, in an image display device such as that of the embodiment, not only partial screen loss but also color breakup and distortion occur easily. For example, there are cases where an easily-viewable display state is not obtained by only displaying the screen for the adjustment and causing the user to adjust the partial screen loss. Conversely, according to the embodiment, the color breakup and the distortion can be suppressed by steps S130 to S150.

The color breakup and the distortion are dependent on the position of the projector 125 with respect to the reflector 130 and the pupil position of the viewer 60. Therefore, it is desirable to first adjust the partial screen loss by adjusting the position of the projector 125 with respect to the reflector 130, and subsequently adjust the color breakup and the distortion. In other words, it is desirable for the second processing (step S110) to be performed before the first processing (steps S130 to S150). Thereby, the viewer 60 can easily adjust the display to an easily-viewable state.

For example, in a method of a reference example, the color breakup and/or the distortion are not considered when displaying the adjustment image and causing the user to adjust the partial screen loss. In such a case, there are cases where the visibility decreases due to the color breakup and the distortion of the adjustment image; and the viewer 60 cannot adjust the partial screen loss sufficiently. Conversely, in the embodiment, for example, as in FIG. 12A, the effect of the color breakup can be suppressed by setting the color of the second pattern P2 to be a primary color. Thereby, the adjustment of the partial screen loss is easy to perform. The effects of the color breakup and the distortion can be suppressed in the case where the third display image MD3 is an image corrected by the correction coefficient. Thereby, the adjustment of the partial screen loss is even easier to perform.

### Third Embodiment

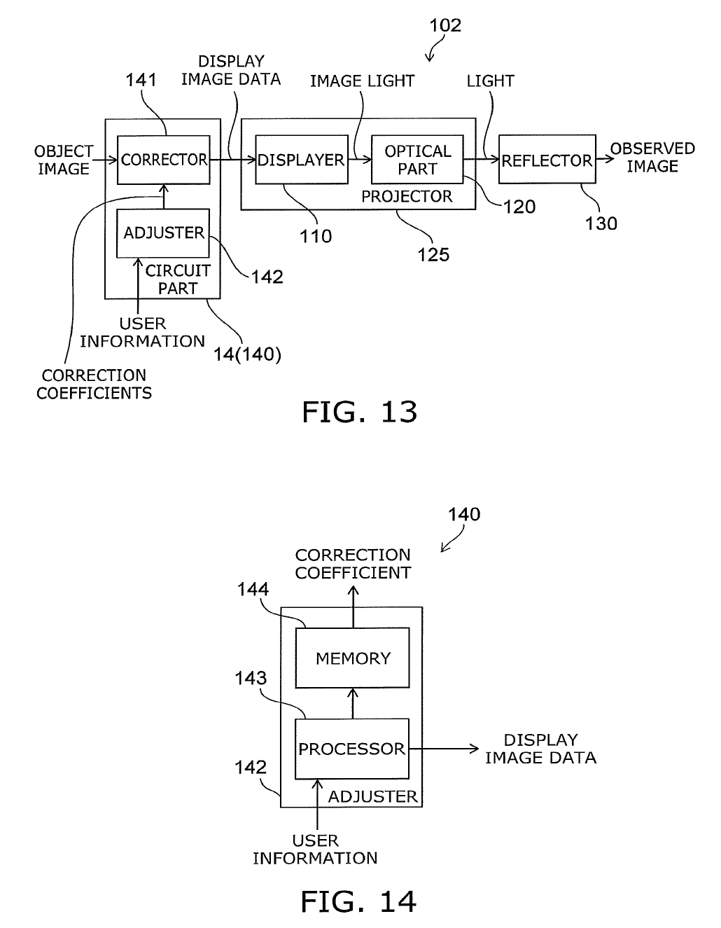

FIG. 13 is a block diagram illustrating an image display device according to a third embodiment.

Similarly to the image display device 101 according to the first embodiment, the image display device 102 according to the embodiment includes the displayer 110, the optical part 120, the reflector 130, etc. These are similar to those of the first embodiment and the second embodiment. The processing of the circuit part 140 of the third embodiment is different from that of the first embodiment or the second embodiment.

As illustrated in FIG. 13, user information (viewer information of the viewer 60, e.g., a user ID, etc.) is input to the circuit part 140 from the outside. The user information is unique information associated with the correction coefficient and is input to the image display device 102 by, for example, the user (the viewer 60). For example, software (an application) is installed in a computer and/or a portable terminal; and the information is input from the viewer 60 to the circuit part 140 via the computer, the portable terminal, etc. The circuit part 140 outputs the data of the display image (the corrected image) from the object image and the input user information.

FIG. 14 is a block diagram illustrating the adjuster according to the third embodiment.

As illustrated in FIG. 14, the adjuster 142 according to the embodiment includes the processor 143 and the memory 144. The memory 144 has a function similar to the function described in the block diagram of the first embodiment.

In the embodiment, the memory 144 can further store the user information. The memory 144 associates and stores the first information (the correction coefficient selected by the user in steps S130 to S150 described above) and the user information of the user. When the user information is input to the adjuster 142 from the outside, the adjuster 142 outputs the correction coefficient to the corrector 141 based on the user information.

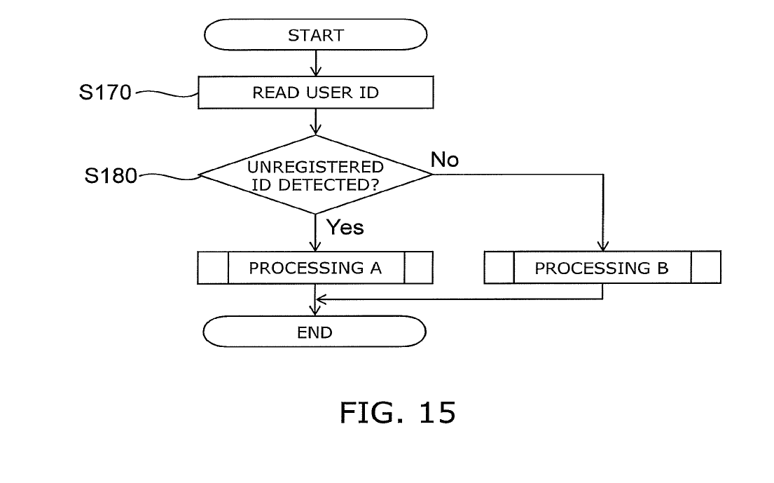

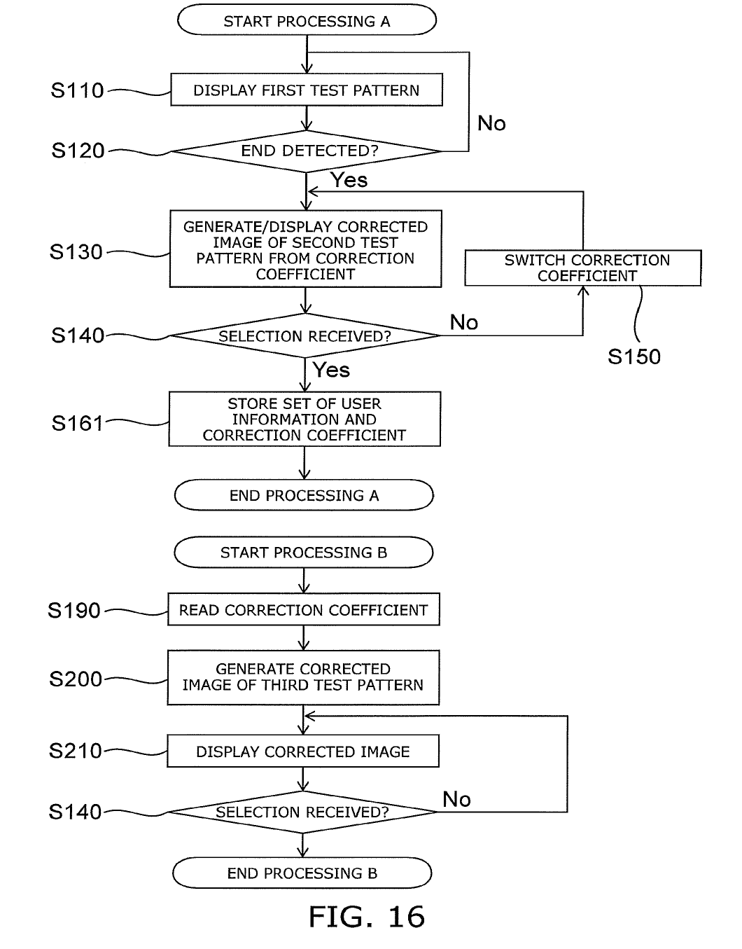

FIG. 15 and FIG. 16 are flowcharts illustrating the adjuster according to the third embodiment.

In step S170, the processor 143 acquires the user information input from the outside by the user.

In step S180, the processor 143 determines whether or not the acquired user information matches pre-registered user information. In other words, in the case where the user information input in step S170 matches the user information already stored in the memory 144, the processor 143 performs processing B; and in the case of no match, the processor 143 performs processing A.

FIG. 16 illustrates the processing A and the processing B. As illustrated in FIG. 16, the processing A includes steps S110, S120, S130, S140, and S150. These are similar to the steps described in the first and second embodiments. The processing A further includes step S161.

Similarly to the description of the first embodiment, the processor 143 receives the signal selecting the correction coefficient in step S140. Subsequently, step S161 is executed. In step S161, the memory 144 associates and stores the user information input in step S170 and the first information (the correction coefficient used to generate the selected display image).

The processing B includes steps S190, S200, S210, and S140.

In step S190, the processor 143 reads the first information (the correction coefficient) associated with the user information input in step S170 from the memory 144.

In step S200, the processor 143 generates a corrected image (a fourth display image) based on the first information.

The fourth display image includes a third test pattern. The third test pattern has a feature similar to the second pattern P2 described in reference to FIG. 12A to FIG. 12C. Or, the third test pattern may include an image based on the first pattern P1 similarly to the display image illustrated in FIG. 9B, etc. In other words, the fourth display image includes at least one of an image indicating the outer perimeter of the fourth display image or an image based on the first pattern P1.

In step S210, the processor 143 causes the projector 125 to emit light including the image information of the fourth display image MD4.

In the case where the fourth display image includes an image indicating the outer perimeter, the viewer 60 can suppress the partial screen loss by modifying the position of the projector 125 while viewing the virtual image of the fourth display image. Here, the correction coefficient (the first information) that is used to generate the fourth display image is selected to suppress the color breakup and the distortion in the state in which the partial screen loss is avoided by the processing A. Therefore, by modifying the projector 125 to the appropriate position, an easily-viewable display can be obtained in which the partial screen loss, the color breakup, and the distortion are suppressed.

In the case where the fourth display image includes the image based on the first pattern P1, the viewer 60 again selects the correction coefficient by a method similar to the description relating to steps S130, S140, and S150 described above. In step S140 in the example of FIG. 16, the processor 143 ends the processing B when receiving the signal selecting the correction coefficient. Thus, the viewer 60 re-performs the selection of the correction coefficient. Thereby, the color breakup and the distortion can be suppressed further. The reselection of the correction coefficient is a fine adjustment of the correction coefficient. Also, by displaying the fourth display image using the first information associated with the user information as in the processing B, the number of steps of the adjustment can be reduced compared to the processing A. Thus, the viewer 60 can more easily adjust the display to an easily-viewable state.

For example, the memory 144 stores the user information associated with the first correction information (the first correction coefficient). At this time, in the case where the user information associated with the first correction information is input in step S170, the processor 143 performs the processing B as a result of the determination in step S180. In step S190 of the processing B, the processor 143 reads the first correction information. Then, in step S200, the processor 143 generates the second corrected image data from the input image (the second input image data) by using the first correction information. In other words, in the example, the second corrected image data is data of the fourth display image MD4 described above. Subsequently, in step S210, the processor 143 causes the projector 125 to emit the second light including the information of the second corrected image data. Thereby, the viewer 60 can adjust the display by using the displayed image (the virtual image).

For the image display devices according to the first to third embodiments, the block diagrams of FIG. 2, FIG. 3, FIG. 13, and FIG. 14 are shown as examples and may not always match the actual modules. For example, a part of each block may be provided separately from the image display device. For example, a part (the memory 144, etc.) of the circuit part 140 may be provided separately from the other part of the circuit part 140 and may be connected to the other part by a wired method, a wireless method, etc.

(Position Controller 126)

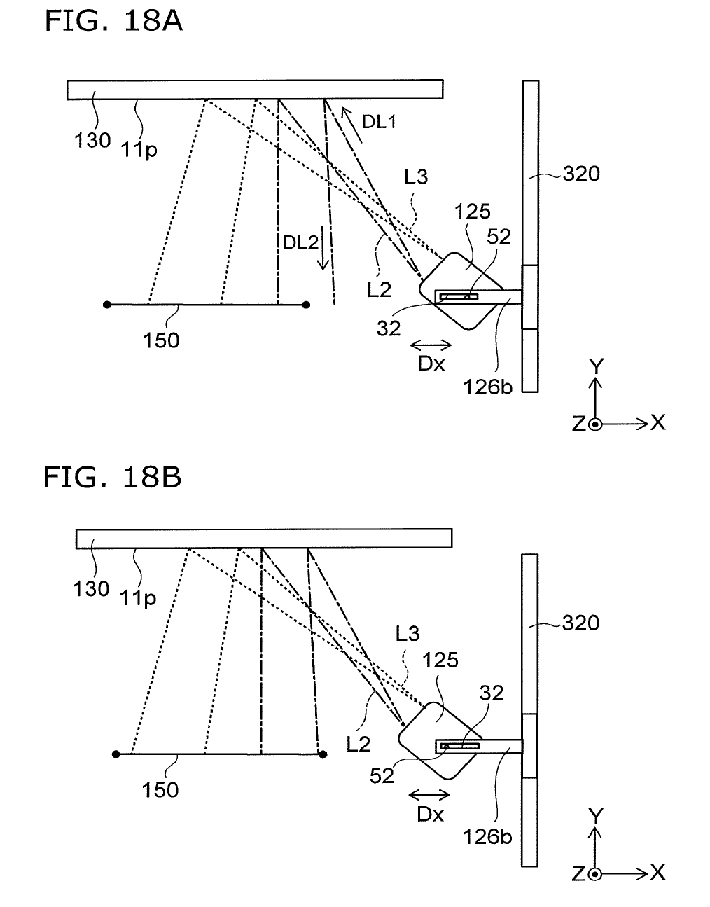

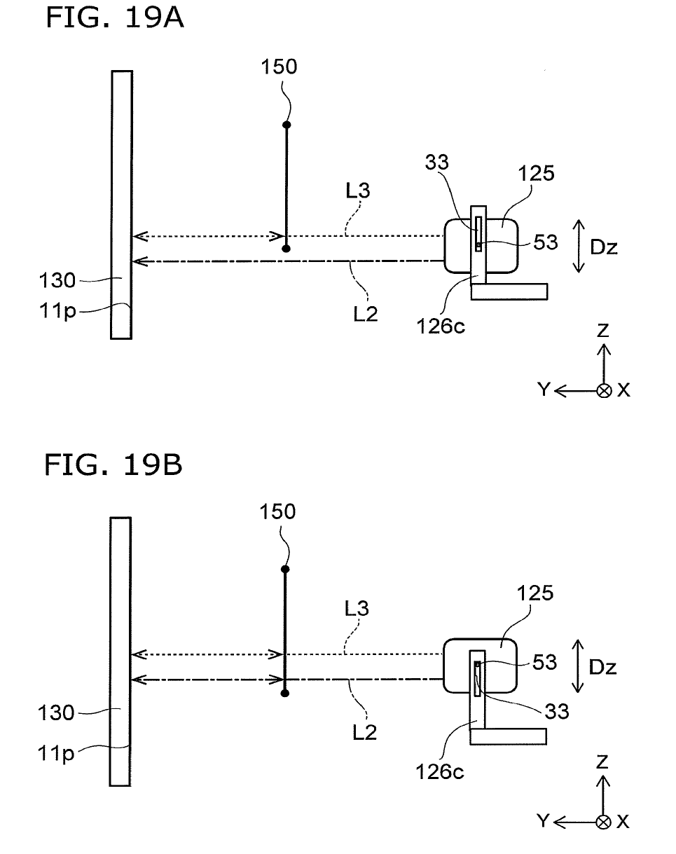

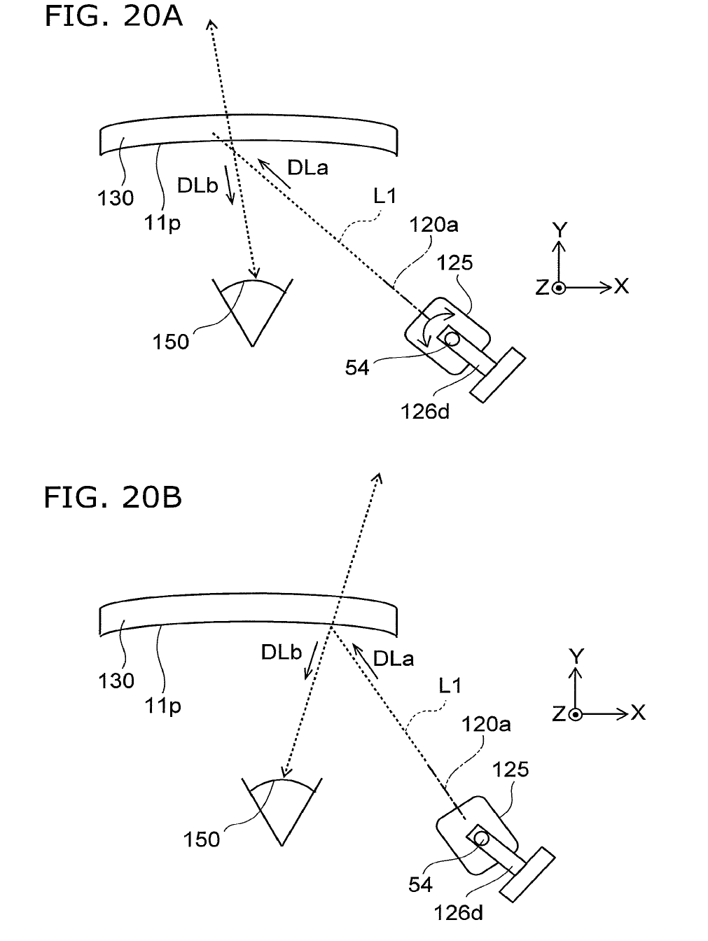

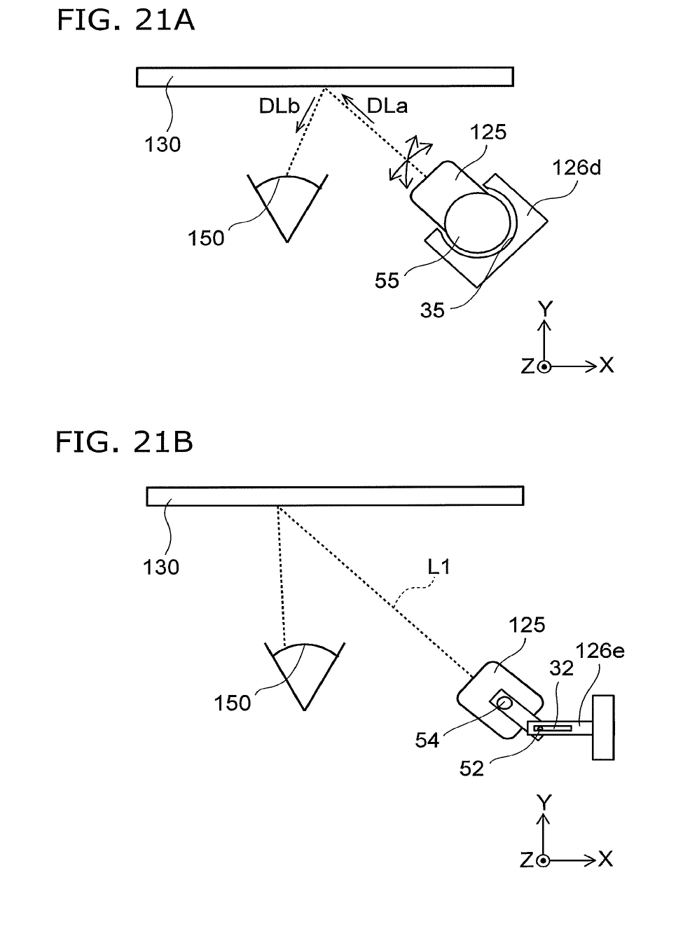

Examples of the position controller 126 used in the image display devices according to the first to third embodiments will now be described with reference to FIG. 17A, FIG. 17B, FIG. 18A, FIG. 18B, FIG. 19A, FIG. 19B, FIG. 20A, FIG. 20B, FIG. 21A, and FIG. 21B.

FIG. 17A and FIG. 17B are schematic views illustrating the image display device according to the embodiment.

In FIG. 17A and FIG. 17B, a position controller 126a is used as an example of the position controller 126. In the example illustrated in FIG. 17A and FIG. 17B, the distance between the projector 125 and the reflector 130 is changeable by the position controller 126a. For example, the distance along the optical axis of the optical part 120 is changeable.

In the example, a long hole 31 is provided along the optical axis of the optical part 120 in the position controller 126a. A movable shaft 51 is provided in the projector 125. The movable shaft 51 is fixed to the projector 125. The movable shaft 51 passes through the long hole 31 and can move by s1iding through the long hole 31. Thereby, the position of the projector 125 can be adjusted. FIG. 17A shows the state in which the distance between the projector 125 and the reflector 130 is long; and FIG. 17B shows the state in which the distance between the projector 125 and the reflector 130 is short.

The optical path of a light L2 emitted from one end of the projector 125 and the optical path of a light L3 emitted from another end of the projector 125 are shown in FIG. 17A and FIG. 17B. In the example of FIG. 17A, the light L3 is reflected by the reflector 130 and is incident on the pupil 150. On the other hand, a part of the light L2 reflected by the reflector 130 is not incident on the pupil 150. Therefore, for example, the viewer 60 cannot view the right edge of the image.

Conversely, as in FIG. 17B, the distance between the reflector 130 and the projector 125 is shortened. Thereby, the spreading of the light L2 at the reflector 130 is suppressed. The correct virtual image can be viewed because the light emitted from the edges of the projector is incident on the pupil.

FIG. 18A and FIG. 18B are schematic views illustrating the image display device according to the embodiment.

A position controller 126b is used as an example of the position controller 126 in FIG. 18A and FIG. 18B. In the example illustrated in FIG. 18A and FIG. 18B, the relative arrangement of the projector 125 and the reflector 130 is changeable by the position controller 126b.

For example, the reflector 130 is provided along the first surface 11p. The arrangement of the projector 125 is changeable in a direction Dx along the first surface 11p. For example, the direction Dx is parallel to a plane including the incident direction (e.g., DL1) and the reflection direction (DL2) at the reflector 130 of the light emitted from the projector 125 (the displayer 110). In the example, the direction Dx is parallel to the X-axis direction. The relative arrangement of the projector 125 and the reflector 130 is changeable in the left/right direction of the viewer 60.

A long hole 32 is provided along the X-axis direction in the position controller 126b. A movable shaft 52 is fixed to the projector 125, passes through the long hole 32, and can move by s1iding through the long hole 32. Thereby, the position of the projector 125 can be adjusted in the left/right direction of the viewer 60. FIG. 18A shows the state in which the projector 125 is disposed on the right side; and FIG. 18B shows the state in which the projector 125 is disposed on the left side. For example, the distance between the projector 125 and the holder 320 in FIG. 18A is shorter than the distance between the projector 125 and the holder 320 in FIG. 18B.

In the example as illustrated in FIG. 18A, a part of the light L2 emitted from the projector 125 is not incident on the pupil 150. Therefore, for example, the viewer 60 cannot view the right edge of the image. Conversely, the projector 125 is moved to the left side as in FIG. 18B. Thereby, the light L2 is incident on the pupil 150. The correct virtual image can be viewed because the light emitted from the edges of the projector is incident on the pupil. The image when viewed by the viewer 60 also moves in the left/right direction according to the movement in the left/right direction of the projector 125.

FIG. 19A and FIG. 19B are schematic views illustrating the image display device according to the embodiment. FIG. 19A and FIG. 19B are side views when viewed from the lateral direction of the viewer 60. A position controller 126c is used as an example of the position controller 126 in FIG. 19A and FIG. 19B. In the example illustrated in FIG. 19A and FIG. 19B, the relative arrangement of the projector 125 and the reflector 130 is changeable by the position controller 126c.

For example, the reflector 130 is provided along the first surface 11p. The arrangement of the projector 125 is changeable in a direction Dz along the first surface 11p. The direction Dz is a direction perpendicular to the first direction Dx described in reference to FIG. 18A. In the example, the direction Dz is parallel to the Z-axis direction. The relative arrangement of the projector 125 and the reflector 130 is changeable in the vertical direction of the viewer 60.

A long hole 33 is provided along the Z-axis direction in the position controller 126c. A movable shaft 53 is fixed to the projector 125, passes through the long hole 33, and can move by s1iding through the long hole 33. Thereby, the position of the projector 125 can be adjusted in the vertical direction of the viewer 60. FIG. 19A shows the state in which the projector 125 is disposed on the lower side; and FIG. 19B shows the state in which the projector 125 is disposed on the upper side.

In the example as illustrated in FIG. 19A, a part of the light L2 emitted from the projector 125 is not incident on the pupil 150. Therefore, for example, the viewer 60 cannot view the lower end of the image. Conversely, as in FIG. 19B, the projector 125 moves to the upper side. Thereby, the light L2 is incident on the pupil 150. The correct virtual image can be viewed because the light emitted from the edges of the projector is incident on the pupil. The image when viewed by the viewer 60 also moves in the vertical direction according to the movement in the vertical direction of the projector 125.

FIG. 20A and FIG. 20B are schematic views illustrating the image display device according to the embodiment. A position controller 126d is used as an example of the position controller 126 in FIG. 20A and FIG. 20B. The relative arrangement of the projector 125 and the reflector 130 is changeable by the position controller 126d.

For example, the optical part 120 has an optical axis 120a. The angle between the optical axis 120a and the first surface 11p is changeable by the position controller 126d. In other words, an incident direction DLa on the reflector 130 of the image light L1 including the image information is changeable by the position controller 126d.

In the example, a position controller 126d includes a rotation shaft 54. The projector 125 is held by the rotation shaft 54. The projector 125 can be rotated with the rotation shaft 54 at the center. For example, the projector 125 can be rotated in the X-Y plane.

FIG. 20A shows the state in which the incident angle of the image light L1 on the reflector 130 is large; and FIG. 20B shows the state in which the incident angle of the image light L1 on the reflector 130 is small.

Thus, an incident direction DLa and a reflection direction DLb of the image light L1 at the reflector 130 can be adjusted by rotating the projector 125. Thereby, the direction in which the image is viewed can be adjusted.

FIG. 21A and FIG. 21B are schematic views illustrating the image display device according to the embodiment. In the example illustrated in FIG. 21A, the incident direction DLa on the reflector 130 of the image light L1 including the image information is changeable by the position controller 126d. A mounting part 55 is provided in the projector 125. For example, the mounting part 55 has the shape of part of a sphere. An opening 35 is provided in the position controller 126d. For example, the opening 35 covers at least a part of the mounting part 55. The mounting part 55 is held by the position controller 126d; and the mounting part 55 can be rotated inside the opening 35. Thereby, the projector 125 can be rotated in the up/down direction and the left/right direction; and the direction in which the image is viewed can be adjusted.

For example, there is a method of a reference example in which the position of the virtual image is adjusted by modifying the position of the reflector 130 without modifying the arrangement of the projector 125. However, in an eyeglasses-type image display device, the relative arrangement of the eyeglasses frame and the eyeglasses lens (the reflector 130) is substantially fixed when using. Therefore, as described above, the relative arrangement of the pupil 150 of the viewer 60 and the reflector 130 is substantially fixed; and there are cases where it is difficult to modify the position of the reflector 130. Conversely, in the embodiment, the arrangement of the projector 125 is modified by the position controller 126. Thereby, for example, the degrees of freedom of the adjustment of the relative arrangement of the reflector 130 and the projector 125 increase.

The mechanisms of the position controller 126 described above are examples; and the embodiment includes any configuration in which the position of the projector can be adjusted similarly. Further, the mechanisms of the position controller 126 described above may be multiply combined. For example, a position controller 126e illustrated in FIG. 21B is an example of a combination of the rotation mechanism in the X-Y plane and the position adjustment mechanism in the left/right direction. In the embodiment, the mechanisms used in the combination and the number of the mechanisms are arbitrary. Thereby, the projector 125 can be disposed at the appropriate position; the position of the image can be adjusted; and an easily-viewable display can be obtained.

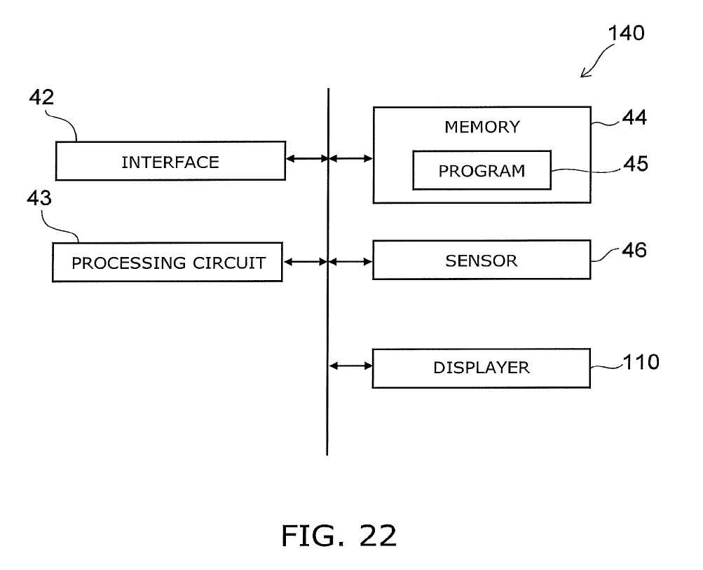

FIG. 22 illustrates an example of the system configuration of the image display device according to the embodiment.

As illustrated in FIG. 22, the circuit part 140 includes, for example, an interface 42, a processing circuit (a processor) 43, and memory 44.

For example, the circuit part 140 is connected to an external storage medium or network via the interface 42 and acquires the object image (the input image). The connection to the outside may include a wired or wireless method. The user information, the information input by the viewer 60 in steps S120, S140, and S150, etc., may be input to the circuit part 140 via the interface 42.

For example, a program 45 that processes the acquired object image is stored in the memory 44. For example, the object image is appropriately corrected based on the program 45; and an appropriate display is performed in the displayer 110 thereby. The program 45 may be provided in a state of being pre-stored in the memory 44, or may be provided via a network or a storage medium such as CD-ROM, etc., and appropriately installed.

The image information may be stored in the memory 44. For example, the information of the first image M1, the first pattern P1, the second pattern P2, etc., may be stored in the memory 44. For example, a part of the memory 44 corresponds to the memory 144 that stores the multiple correction coefficients.

The circuit part 140 may include a sensor 46. The sensor 46 may include, for example, any sensor such as a camera, a microphone, a position sensor, an acceleration sensor, etc. For example, the image that is displayed by the displayer 110 is modified appropriately based on the information obtained from the sensor 46. Thereby, the convenience and ease of viewing of the image display device can be improved. The position information relating to the relative arrangement of the projector 125 and the reflector 130 may be sensed by the sensor 46.

The information obtained from the sensor 46, the image information, etc., are processed in the processing circuit 43 based on the program 45. Thus, the obtained image information is input from the circuit part 140 to the displayer 110; and the display is performed by the image display device. For example, a part of the processing circuit 43 corresponds to the corrector 141 and the processor 143; and the processing of the adjuster 142 and the corrector 141 is performed in the processing circuit 43 based on the program 45.

The example illustrated in FIG. 22 is an example of the image display device according to the embodiment and may not always match the actual modules.

A part of each block or each entire block of the circuit part 140 may include an integrated circuit such as LSI (Large Scale Integration), etc., or an IC (Integrated Circuit) chipset. Each block may include an individual circuit; or a circuit in which some or all of the blocks are integrated may be used. The blocks may be provided as one body; or some blocks may be provided separately. Also, for each block, a part of the block may be provided separately. The integration is not limited to LSI; and a dedicated circuit or a general-purpose processor may be used.

### Fourth Embodiment

The embodiment differs from the first embodiment in that the aspect ratio of the observed image is corrected using the correction coefficient.

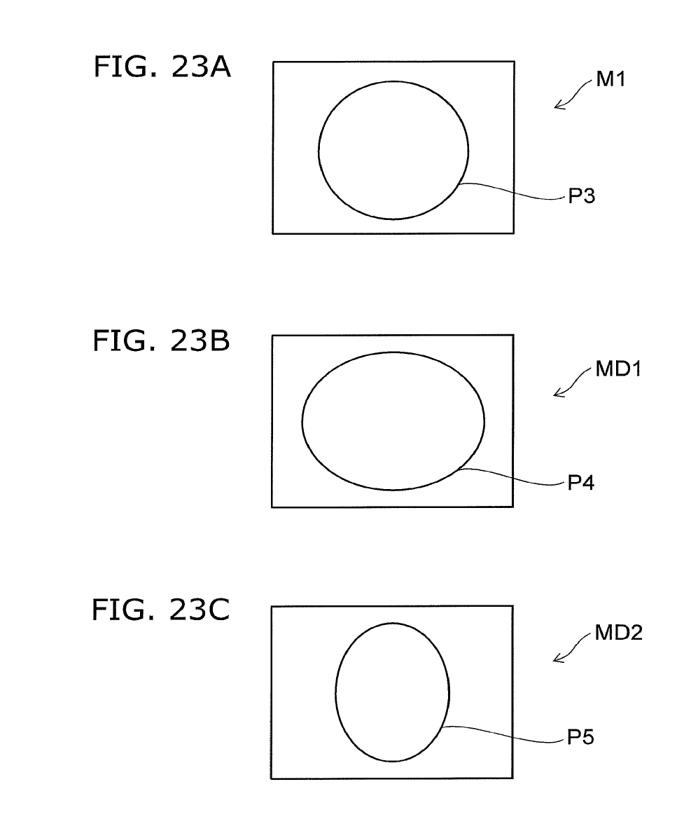

FIG. 23A to FIG. 23C are schematic views illustrating test patterns used in the processing of the image display device according to the fourth embodiment.

In the embodiment, the first image includes a third pattern (the third test pattern). FIG. 23A is an example of the first image M1 including the third pattern P3. The third pattern P3 that is included in the first image M1 is, for example, a circle. FIG. 23B is the display image (the first display image MD1) generated using the first correction coefficient from the first image M1. FIG. 23C is the display image (the second display image MD2) generated using the second correction coefficient from the first image M1.

A fourth pattern P4 that is included in the first display image MD1 of FIG. 23B and a fifth pattern P5 that is included in the second display image MD2 of FIG. 23C each are patterns in which the third pattern P3 is corrected. The aspect ratio of the third pattern P3, the aspect ratio of the fourth pattern P4, and the aspect ratio of the fifth pattern P5 are different from each other. The image display device 101 displays the multiple display images having mutually-different aspect ratios. Processing is performed to cause the viewer 60 to select the correction coefficient having the appropriate aspect ratio for the viewer 60 by causing the viewer 60 to select the display image. Thereby, the viewer 60 can easily adjust the display to an easily-viewable state. The image display device 101 generates the second corrected image data of the second input image data corrected based on the selected correction coefficient; and the image display device 101 emits the second light based on the second corrected image data.

According to the embodiments, an image display device and an image processing device can be provided in which the viewer can adjust the display to an easily-viewable state.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the invention is not limited to these specific examples. For example, one skilled in the art may similarly practice the invention by appropriately selecting specific configurations of components such as the projector, the reflector, the circuit part, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all image display devices and image processing devices practicable by an appropriate design modification by one skilled in the art based on the image display devices and image processing devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image display device, comprising:
an optical part; and
a controller, first input image data and second input image data being input to the controller, the controller causing the optical part to emit a first light, the first light being based on first corrected image data of the first input image data having been corrected, the controller causing the optical part to emit a second light to the optical part when receiving a signal employing first correction information, the second light being based on second corrected image data of the second input image data having been corrected based on the first correction information, the first correction information being of a relationship between the first input image data and the first corrected image data.

2. The image display device according to claim 1, wherein the controller causes the optical part to emit the first light and a third light, the first light is based on the first corrected image data of the first input image data having been corrected, the third light is based on third corrected image data, the third corrected image data is different from the first corrected image data and is of the first input image data having been corrected, the controller causes the optical part to emit the second light when receiving the signal employing the first correction information of the relationship between the first input image data and the first corrected image data, the second light is based on the second corrected image data of the second input image data having been corrected based on the first correction information.

3. The image display device according to claim 2, wherein
the first corrected image data includes data of a first image of at least a part of the first input image data having been corrected,
the third corrected image data includes data of a second image of the at least a part of the first input image data having been corrected, and
a shape of the first image is different from a shape of the second image.

4. The image display device according to claim 3, wherein
the first image includes a third image of a first color and a fourth image of a second color,
the second image includes a fifth image of the first color and a sixth image of the second color, and
a positional relationship between the third image and the fourth image is different from a positional relationship between the fifth image and the sixth image.

5. The image display device according to claim 1, further comprising a reflector reflecting at least a part of the first light and at least a part of the second light emitted from the optical part.

6. The image display device according to claim 5, wherein
third input image data is further input to the controller, and
the optical part emits light, the light includes information of a display image and information of an image instructing a viewer to use the display image to change at least one of a relative arrangement of the optical part and the reflector, a relative arrangement of the optical part and an eye of the viewer, or a relative arrangement of the reflector and the eye, the display image is based on the third input image data.

7. The image display device according to claim 1, wherein
the first input image data includes first color input image data and second color input image data, the first color input image data relates to a first color, the second color input image data relates to a second color,
the first corrected image data includes first color corrected image data and second color corrected image data, the first color corrected image data relates to the first color, the second color corrected image data relates to the second color, and
the first correction information includes first color correction information and second color correction information, the first color correction information is of a relationship between the first color input image data and the first color corrected image data, the second color correction information is different from the first color correction information and is of a relationship between the second color input image data and the second color corrected image data.

8. The image display device according to claim 1, wherein the controller stores viewer information, and the controller causes the optical part to emit the second light when the viewer information is input, the viewer information is of a viewer and is associated to the first correction information, the second light is based on the second corrected image data.

9. The image display device according to claim 6, wherein the display image based on the third input image data includes a pattern of an outer perimeter of the display image.

10. The image display device according to claim 9, wherein a color of the pattern is one of red, blue, or green.

11. The image display device according to claim 1, wherein
the first input image data is data of a first image including a first pattern, and
the first pattern includes a first element extending in a first direction inside the first image.

12. The image display device according to claim 11, further comprising a reflector reflecting at least a part of the first light and at least a part of the second light emitted from the optical part,
the first direction being determined based on a relative arrangement of the optical part and the reflector.

13. The image display device according to claim 12, wherein the first pattern further includes a second element, the second element extends in the first direction and is arranged with the first element in a second direction inside the first image, the second direction crosses the first direction.

14. The image display device according to claim 1, further comprising a reflector reflecting at least a part of the first light and at least a part of the second light emitted from the optical part,
the first correction information being determined based on a positional relationship between the optical part and the reflector.

15. An image processing device comprising a controller, first input image data and second input image data being input to the controller, the controller outputting a first corrected image data of the first input image data having been corrected, the controller outputting second corrected image data when receiving a signal employing first correction information, the first correction information being of a relationship between the first input image data and the first corrected image data, the second corrected image data being of the second input image data corrected based on the first correction information.

16. The image processing device according to claim 15, wherein
the controller outputs the first corrected image data and third corrected image data, the first corrected image data is of the first input image data having been corrected, the third corrected image data is different from the first corrected image data and is of the first input image data having been corrected, and
the controller outputs the second corrected image data when receiving the signal employing the first correction information of the relationship between the first input image data and the first corrected image data, the second corrected image data is of the second input image data corrected based on the first correction information.

17. The image processing device according to claim 16, wherein
the first corrected image data includes data of a first image of at least a part of the first input image data having been corrected,
the third corrected image data includes data of a second image of the at least a part of the first input image data having been corrected, and
a shape of the first image is different from a shape of the second image.

18. The image processing device according to claim 17, wherein
the first image includes a third image of a first color and a fourth image of a second color,
the second image includes a fifth image of the first color and a sixth image of the second color, and
a positional relationship between the third image and the fourth image is different from a positional relationship between the fifth image and the sixth image.
